(19) United States
(12) Patent Application Publication
(10) Pub. No.: US 2025/0353769 A1
(43) Pub. Date: Nov. 20, 2025

(54) WATER TREATMENT SYSTEM USING A MAGNETIC CONFINEMENT METHOD

(71) Applicant: THE HONG KONG POLYTECHNIC UNIVERSITY, Hong Kong (CN)

(72) Inventors: Yi JIANG, Hong Kong (CN); Delai ZHONG, Hong Kong (CN); Yuchen WU, Hong Kong (CN)

(21) Appl. No.: 18/871,188

(22) PCT Filed: Jul. 5, 2023
(86) PCT No.: PCT/CN2023/105929

§ 371 Date: Dec. 3, 2024

Related U.S. Application Data
(60) Provisional application No. 63/367,650, filed on Jul. 5, 2022.

(51) Int. Cl. C02F 9/00; B01D 65/02; B01D 69/08; B01D 69/14; B03C 1/015; C02F 1/44; C02F 1/48; C02F 1/72; C02F 101/10

(52) U.S. Cl. CPC C02F 9/00; B01D 65/02; B01D 69/08; B01D 69/145; B03C 1/015; B01D 2321/04; B03C 2201/18; C02F 1/44; C02F 1/482; C02F 1/725; C02F 2101/103; C02F 2303/16

(57) ABSTRACT

A water treatment system for removing contaminant from a feed solution is provided. The system includes a hollow fiber membrane chemical reactor (HF-MCR) and a magnetic field generator; or a magnetic confinement-enabled column reactor (MCCR) comprising one or more column filters and a magnetic field generator. The magnetic field generator is arranged to produce a magnetic field for realizing a magnetically confined zone that results in a formation of a plurality of microwires comprising the zerovalent iron (ZVI) nanoparticles or a plurality of ZVI wires comprising ZVI microparticles. The plurality of microwires can be a magnetic catalyst to enable catalytic degradation and chemical immobilization of the contaminant. The plurality of ZVI wires can reduce aqueous As (As_{aq}) concentration in the feed solution after the feed solution is pumped through the one or more column filters.

### CROSS-REFERENCE TO RELATED APPLICATIONS

This application claims the benefit of the U.S. Provisional Patent Application No. 63/367,650, filed on Jul. 5, 2022, which is incorporated by reference herein in its entirety.

### FIELD OF THE INVENTION

The present disclosure generally relates to a water treatment system. In particular, the present disclosure relates to a novel water treatment system that uses magnetic fields to efficiently remove multiple pollutants from complex waters.

### BACKGROUND OF THE INVENTION

The demand for safe and clean water is increasing, leading to the exploration of unconventional water sources such as wastewater. This drives the development of innovative water treatment technologies, with the ultimate goal of providing safe and clean water to all.

Ultrafiltration (UF) and microfiltration (MF) are popular wastewater reclamation technologies, which both can reliably produce high-quality permeate at an affordable cost and with high throughput. However, traditional UF and MF systems remove primarily large pollutants, and struggle to remove small or dissolved contaminants, such as bisphenol A (BPA), phosphorus (P), and arsenic (As). These contaminants, even at trace levels, can have severe consequences for human health and aquatic environments.

As contamination of groundwater is a global issue that poses a significant threat to human health. It is estimated that approximately 94-220 million people worldwide are exposed to unsafe As levels (>10 μg/L) by consuming groundwater without or with low effective treatments. Arsenicosis remains a frequent diagnosis in rural households of developing countries such as Bangladesh, China, and Vietnam. Common drinking water treatment plants can treat high As groundwater, but As-affected underdeveloped areas typically lack access to such infrastructures.

To tackle the challenge of removing small or dissolved contaminants, recent advancements have combined the UF and MF systems with chemical reactions, such as advanced oxidation processes (AOPs), in a single unit known as a membrane chemical reactor (MCR). This integrated approach offers multiple decontamination mechanisms, enabling simultaneous removal of a wide spectrum of micropollutants via multiple decontamination mechanisms, such as solute membrane retention, chemical degradation, or precipitation. Furthermore, smart integrated configurations of membrane separation and AOPs, such as sequential separation and reaction of contaminants, enable enhanced and selective chemical reactions within the nanoconfinement of membrane pores, significantly improving treatment efficiency compared with separate units.

Despite the demonstrated superiority and promising potential of the MCRs for advanced water treatment, their application for both continuous flow-through and flow-by water treatments remains hindered by critical technical issues, including inconvenient catalyst loading and reloading, as well as deactivation and leaching of the catalyst. Conventional catalyst loading methods, such as adsorption, precipitation, electrospinning, and deposition, require complicated treatment steps, including surface pre-modification, introduction of loading reactions, and further stabilization. These steps can significantly reduce catalyst loading efficiency, and lead to uneven distribution of the catalyst due to uncontrollable loading reactions. Additionally, membrane resistance may increase, with consequent water flux decrease, when the membrane channel is narrowed or blocked by the catalyst. Moreover, available catalytic sites might be shielded by the membrane polymer if they are incorporated during membrane formation.

Deactivation of catalysts, such as zerovalent iron (ZVI), can limit or even terminate the catalytic decontamination process. Current technologies to address ZVI deactivation include surface modification, lowering working pH, adding complexing agents, and applying weak magnetic fields. However, these methods may cause secondary contamination or narrow the working pH range. Furthermore, a common leaching issue can reduce the available amounts of catalysts, particularly in continuous single-pass processes, making it difficult to sustain high catalytic decontamination. Reloading is a general solution to maintain catalytic reactivity, but it is often inefficient or impossible to achieve using conventional loading methods.

For As contamination of groundwater, sand filters are widely used for groundwater treatment in households in areas affected by arsenicosis. Although sand filters can be effective in treating high-As groundwater by allowing 02 to access Fe(II) in the groundwater, triggering oxidative precipitation of Fe(II) for As(III) oxidation and capture, they often fail to provide safe and satisfactory As removal, especially for groundwater with low Fe concentrations. Consequently, Fe(II) is commonly supplemented to improve As removal performance, such as using low-cost ZVI. Nevertheless, during the ZVI oxidative corrosion, in-situ generated iron (oxyhydr)oxides tend to accumulate on the ZVI surface, causing passivation and reactivity loss over time. However, such filters offer limited As removal performance and water treatment capacity, primarily due to the ZVI surface passivation and filter clogging. To date, the issues associated with ZVI passivation and filter clogging have not been adequately addressed.

Accordingly, there is a need for a next-generation distributed water treatment technology that can achieve sustained removal of small or even dissolved contaminants, ensuring the provision of clean and safe water for all. Furthermore, other desirable features and characteristics will become apparent from the subsequent detailed description and the appended claims, taken in conjunction with the accompanying drawings and this background of the disclosure.

### SUMMARY OF THE INVENTION

Provided herein is a water treatment system that uses magnetic fields to efficiently remove multiple pollutants from complex waters.

In certain aspects of the present disclosure, a system for removing contaminant from a feed solution using a sequential combination of filtration and catalysis is disclosed. The system includes a hollow fiber membrane chemical reactor (HF-MCR) and a magnetic field generator. The HF-MCR includes a filtration zone at a frontend of the HF-MCR, a catalysis zone at a backend of the HF-MCR, and one or more hollow fiber membranes (HFMs) disposed across the filtration zone and the catalysis zone. The filtration zone includes a filtration chamber and an inlet. The catalysis zone is a magnetically confined zone. The one or more HFMs disposed across the catalysis zone comprise zerovalent iron (ZVI) nanoparticles. The magnetic field generator is arranged to produce a magnetic field around the one or more HFMs at the catalysis zone for realizing the magnetically confined zone that results in a formation of a plurality of microwires comprising the ZVI nanoparticles in a lumen of each of the one or more HFMs as a magnetic catalyst to enable catalytic degradation and chemical immobilization of the contaminant. The filtration chamber is filled with the feed solution from the inlet, and the HFM establishes a fluid communication between the filtration chamber and the one or more HFMs as means for communicating the feed solution into the one or more HFMs under an outside-in mode at the filtration zone.

In an embodiment, the system includes a first pump for loading and reloading the catalysis zone with a ZVI suspension comprising the ZVI nanoparticles. The ZVI suspension forms the plurality of microwires in a presence of the magnetic field.

In an embodiment, the ZVI suspension is injected into the one or more HFMs with a water flow rate ranging from 2 cm/s to 15 cm/s such that the ZVI nanoparticles are localized in the magnetically confined zone for forming the plurality of microwires having interspaces between the plurality of microwires.

In an embodiment, the system includes a second pump and a third pump. The second pump injects an oxidant solution into the one or more HFMs, and the third pump injects the feed solution to the filtration chamber via the inlet in a dead-end filtration mode.

In an embodiment, the oxidant solution comprises peroxymonosulfate (PMS), peroxydisulfate, hydrogen peroxide, or dissolved O₂ or O₃.

In an embodiment, the feed solution, upon filtering nanoplastics (NPs) by the HFM, is mixed with the oxidant solution in the one or more HFMs with a water flux ratio ranging from 10:1 to 100:1.

In an embodiment, the filtration zone includes an outlet for discharging the feed solution in a backwashing mode for membrane washing.

In an embodiment, the magnetic field generator includes a plurality of magnets sandwiching the HF-MCR at the catalysis zone. The plurality of magnets comprises a neodymium (NdFeB) magnet, a samarium-cobalt magnet, an Alnico magnet, a ferrite magnet, or an electromagnet.

In an embodiment, the plurality of magnets forms a diametrically magnetized ring magnet arranged to surround the one or more HFMs.

In an embodiment, the plurality of magnets comprises a stack of eight cylindrical NdFeB magnets arranged to sandwich the HF-MCR with a gap of a predetermined thickness. The magnetic field is oriented perpendicular to a water flow direction of the feed solution and the oxidant solution in the one or more HFMs, thereby the plurality of microwires are aligned vertically to improve hydrodynamic stability.

In an embodiment, the HFM is a polytetrafluoroethylene (PTFE) membrane, a polyethersulfone (PES) membrane, a polyvinylidene fluoride (PVDF) membrane, or a ceramic membrane, with a membrane pore size of 10-100 nm.

In an embodiment, the contaminant includes one or more contaminants comprising colloids, bisphenol A (BPA), bisphenol F (BPF), bisphenol S (BPS), sulfamethoxazole (SMX), dichlorophenol (DCP), nitrophenol (NP), acetaminophen (APAP), trichloroacetic acid (TCAA), phosphorus (P) containing pollutants, arsenic (As) containing pollutants, and antimony (Sb) containing pollutants.

In certain aspects of the present disclosure, a method for removing contaminant from a feed solution using a HF-MCR is provided. The HF-MCR includes a filtration zone, a catalysis zone, and an HFM disposed across the filtration zone and the catalysis zone. The method includes the steps of (1) injecting, by a first pump, a ZVI suspension comprising zerovalent iron (ZVI) to the HFM for forming a plurality of microwires comprising ZVI nanoparticles by a magnetic field in a lumen of the catalysis zone as a magnetic catalyst; (2) injecting, by a second pump, an oxidant solution to the HFM; (3) injecting, by a third pump, the feed solution to a filtration chamber of the filtration zone; (4) establishing a fluid communication of the feed solution from the filtration chamber to the HFM under an outside-in mode to mix with the oxidant solution; and (5) activating the oxidant solution in the catalysis zone by the plurality of microwires to enable catalytic degradation and chemical immobilization of the contaminant from the feed solution.

In an embodiment, the catalysis zone is sandwiched between two sets of magnets for realizing a magnetically confined zone. The magnetic field is oriented perpendicular to a flow direction of the feed solution and the oxidant solution in the HFM.

In an embodiment, the method further includes the step of injecting, from time-to-time, by the first pump, the ZVI suspension comprising the ZVI nanoparticles into the HFM for reloading the ZVI nanoparticles in the catalysis zone.

In an embodiment, the method further includes the step of discharging, from time-to-time, the feed solution from the filtration chamber in a backwashing mode for membrane washing.

In certain aspects of the present disclosure, a system for removing arsenic (As) from a feed solution is provided. The system includes a magnetic confinement-enabled column reactor (MCCR) and an ultrasonic generator. The MCCR is a flow-through reactor including one or more column filters oriented along a vertical direction, and a magnetic field generator. Each of the one or more column filters is filled with ZVI. The magnetic field generator is arranged to produce a magnetic field around the one or more column filters for realizing a magnetically confined zone that results in a formation of a plurality of ZVI wires comprising ZVI microparticles within the one or more column filters for reducing aqueous As (As_{aq}) concentration in the feed solution after the feed solution is pumped through the one or more column filters. The ultrasonic generator is coupled to the one or more column filters and capable of periodically applying ultrasonic energy to the plurality of ZVI wires to sustain reactivity.

In an embodiment, the one or more column filters are arranged in parallel. Each of the one or more column filters comprises an upper outlet and a lower inlet for allowing the feed solution to flow in a bottom-up flow direction.

In an embodiment, the one or more column filters includes three column filters connected in tandem by a plurality of pipelines. The feed solution is pumped into the MCCR from the lower inlet.

In an embodiment, the system further includes a peristaltic pump configured to pump the feed solution into the lower inlet of the first column filters.

In an embodiment, the three column filters comprise a first column filter, a second column filter, and a third column filter, wherein the feed solution is pumped into the lower inlet of the first column filter. The first column filter is in fluid communication with the second column filter by connecting a first pipeline from the upper outlet of the first column filter to the lower inlet of the second column filter. The second column filter is in fluid communication with the third column filter by connecting a second pipeline from the upper outlet of the second column filter to the lower inlet of the third column filter.

In an embodiment, the ultrasonic generator is configured to be activated, from time to time, to apply the ultrasonic energy to the one or more column filters to eliminate surface passivation of the ZVI microparticles in the plurality of ZVI wires.

In an embodiment, the ultrasonic generator has an ultrasonic frequency ranging from 40 kHz to 100 kHz.

In an embodiment, the system further includes an air pump and a hydrophobic filter, wherein the air pump is configured to inject air into the feed solution for improving dissolved oxygen (DO) concentration.

In an embodiment, the magnetic field generator includes a plurality of magnets sandwiching the MCCR, and wherein the plurality of magnets comprises a NdFeB magnet, a samarium-cobalt magnet, an Alnico magnet, a ferrite magnet, or an electromagnet.

In an embodiment, the plurality of magnets and the one or more column filters are arranged in an interleaving manner, and each of the one or more column filters is sandwiched by two of the plurality of magnets.

In an embodiment, the magnetic field has a magnetic flux density of 0.3 T to 0.6 T.

In certain aspects of the present disclosure, a method for removing arsenic (As) from a feed solution using a MCCR is provided. The MCCR includes one or more column filters vertically arranged and a magnetic field generator. The method includes the steps of (1) loading ZVI microparticles to the MCCR by filling the one or more column filters with microscale ZVI, wherein the magnetic field generator induces a magnetic field around the one or more column filters for realizing a magnetically confined zone that results in a formation of a plurality of ZVI wires comprising the ZVI microparticles within the one or more column filters; (2) injecting, by a peristaltic pump, the feed solution into the one or more column filters in a bottom-up flow direction; and (3) activating, from time to time, an ultrasonic generator to apply ultrasonic energy to the plurality of ZVI wires to sustain reactivity.

In an embodiment, the ultrasonic generator is activated regularly for approximately 1 minute based on a periodic ultrasonic depassivation (PUD) frequency that is determined based on a flow rate of the feed solution, thereby surface passivation of the ZVI microparticles in the plurality of ZVI wires is eliminated.

In an embodiment, the PUD frequency ranges from 2 hours to 24 hours.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Other aspects and advantages of the present invention are disclosed as illustrated by the embodiments hereinafter.

### BRIEF DESCRIPTION OF THE DRAWINGS

The appended drawings contain figures to further illustrate and clarify the above and other aspects, advantages, and features of the present disclosure. It will be appreciated that these drawings depict only certain embodiments of the present disclosure and are not intended to limit its scope. It will also be appreciated that these drawings are illustrated for simplicity and clarity and have not necessarily been depicted to scale. The present disclosure will now be described and explained with additional specificity and detail through the use of the accompanying drawings in which:

FIG. 1 depicts a schematic diagram of the water treatment system in accordance with the first embodiment of the present disclosure.

FIG. 2 depicts an illustration showing the removal of multiple contaminants from a solution using a sequential combination of filtration and catalysis in accordance with an exemplary embodiment of the present disclosure.

FIG. 3 depicts the structure of the hollow fiber membrane chemical reactor (HF-MCR) in accordance with an exemplary embodiment of the present disclosure.

FIG. 4 shows the photos of the ZVI suspension comprising ZVI nanoparticles, and the effluent after the feed solution passes through the HF-MCR of FIG. 3 for ZVI loading.

FIG. 5 depicts the ZVI concentration in the effluent at different water flow rate for demonstrating the ZVI hydrodynamic stability after ZVI loading and before decontamination.

FIG. 6 shows the experimental results regarding the effect of the water flow velocity on the distribution of the ZVI microwires.

FIG. 7 depicts a drawing summarizing the results of FIG. 6.

FIG. 8 depicts the magnetic force acting on a magnetized ZVI rod for simulating a microwire in the magnetic field.

FIG. 9 depicts the simulated magnetic force acting on a ZVI rod along the Y axis in the magnetic field.

FIG. 10 depicts the formation of the plurality of ZVI microwires in the lumen of the HFM.

FIGS. 11A and 11B depict the vertical formation of the plurality of ZVI microwires by magnetic attraction force in the magnetic field, and the change in magnetic attraction force as a function of the distance between the ZVI nanoparticles.

FIGS. 12A and 12B depict the interspace formation of the plurality of ZVI microwires by magnetic repulsion force in the magnetic field, and the change in magnetic repulsion force as a function of the distance between the ZVI nanoparticles.

FIGS. 13A and 13B depict the photographs of the plurality of ZVI microwires magnetically confined in the lumen along the Z-Y plane and the Z-X plane respectively.

FIGS. 14A and 14B show the dynamic dissolution and partial residues of the pluralty of microwires after HCl treatment in the magnetic field.

FIG. 14C shows the uniform decolorization of Rhodamine B in the HF-MCR.

FIGS. 15A-C depict the effectiveness of the removal of pollutants in FC mode, F mode, and C mode.

FIG. 16A depicts NPs removal in the only catalysis mode of the HF-MCR.

FIG. 16B shows the FE-SEM images of solid products collected from the effluent of the HF-MCR in only catalysis mode in the initial stage (a,b) and late stage (c,d).

FIG. 17 depicts the change in water flux with cumulative effluent volume.

FIG. 18 shows the dynamic corrosion of the plurality of ZVI microwires by PMS under different flux conditions.

FIG. 19 shows (a) the removal of NPs, BPA, and P in the HF-MCR with periodic washing and reloading of ZVI, (b) the changes in water flux, and (c) F⁻release in the effluent.

FIG. 20 shows the FE-SEM images of the interior surface of a new HFM (a1,a2), a used HFM from the filtration zone (b1,b2), and a used HFM from the catalysis zone (c1,c2), after 9 cycles of test.

FIG. 21 depicts a schematic showing possible scale-up of the HF-MCR in accordance with an exemplary embodiment of the present disclosure.

FIG. 22 depicts a schematic diagram of the water treatment system in accordance with the second embodiment of the present disclosure.

FIG. 23A depicts fractions of As removal in the three column filters of the MCCR with PUD.

FIG. 23B depicts the photos of the plurality of ZVI wires formed inside the one or more column filters.

FIG. 24A depicts the thickness distribution of the plurality of ZVI wires.

FIG. 24B depicts the gap distribution of interspace of the plurality of ZVI wires.

FIG. 25 depicts the comparison of the normalized surface area and porosity between the conventional sand filter and the MCCR of the present disclosure.

FIG. 26 shows the CT views of the structure of pristine ZVI wires (P-ZVI), passivated ZVI wires without PUD (w/o PUD), and ZVI wires with PUD.

FIG. 27 depicts the concentration of Fe⁰ in the effluent as a function of water flow velocity to show the hydrodynamic stability.

FIG. 28A depicts the As partition of a sand filter.

FIG. 28B depicts the As partition of a MCCR without PUD.

FIG. 28C depicts the As partition of a MCCR with PUD.

FIG. 29A depicts the Fe concentration in the effluent for sand filter, MCCR without PUD, and MCCR with PUD.

FIG. 29B depicts the dissolved oxygen in the effluents for sand filter, MCCR without PUD, and MCCR with PUD.

FIG. 29C depicts the flow rates of the sand filter, MCCR without PUD, and MCCR with PUD.

FIG. 30 depicts the concentration of As in the aqueous and solid phase of effluent for sand filter, MCCR without PUD, and MCCR with PUD.

FIG. 31 depicts the fractions of As in different phases of the sand filter, MCCR without PUD, and MCCR with PUD.

FIG. 32 depicts the As speciation in the aqueous phase.

FIG. 33A depicts the concentrations of total and aqueous As in the effluents of the MCCR with PUD.

FIG. 33B depicts the concentrations of total and aqueous Fe in the effluents of the MCCR with PUD.

FIG. 34A depicts the size distribution of effluent solids from the MCCR with PUD.

FIG. 34B depicts the size distribution of the displaced passivation film from the MCCR with PUD.

FIGS. 35A-D depict the concentrations of (a) total As, (b) aqueous As, (c) total Fe, and (d) aqueous Fe in the supernatant of effluents collected at the running time of 2, 6, 24 and 48 h.

FIG. 36A depicts the As_{aq} concentration in the effluent of the MCCR with PUD under different flow rates.

FIG. 36B depicts the As_{aq} concentration in the effluent of the MCCR with PUD under different PUD frequencies.

FIG. 36C depicts the comparison of 1/EBCT and iron utilization efficiency between the MCCR with PUD (15 mL/min and 12 hours of PUD frequency) and other ZVI or iron oxide-based filters reported by the previous studies.

FIG. 37A shows the SEM images of the ZVI corrosion products in the effluent solids and the displaced passivation film in MCCR with PUD.

FIG. 37B shows the TEM images of the ZVI corrosion products in the displaced passivation film in MCCR with PUD.

FIG. 37C shows the SEM images of the column solids in sand filter and MCCR without PUD.

FIG. 37D shows the TEM images of the corrosion products in sand filter and MCCR without PUD.

FIG. 38A depicts the FTIR spectra for analyzing the chemical composition of the corrosion products.

FIG. 38B depicts the XRD pattern for analyzing the crystal structure of the corrosion products.

FIG. 39 depicts the experimental data of the As K-edge XANES spectra of ZVI reacted with As(III).

FIG. 40A depicts the Normalized k³-weighted experimental (scatter points) and simulated (lines) As K-edge EXAFS spectra of As in the solids from the sand filter, MCCR without PUD, and MCCR-PUD.

FIG. 40B depicts the Fourier transformed magnitude of FIG. 40A.

FIG. 40C depicts the imaginary parts of the Fourier transform of FIG. 40B.

FIG. 41 depicts the coordination geometries of FeO6 octahedra in a ferric hydroxide cluster and linkages of AsO₄ tetrahedra to the cluster.

FIG. 42 depicts the fractions of As extracted in the three steps of the sequential extraction procedure.

FIG. 43A depicts the concentration of released aqueous As from ZVI corrosion products with time during the aging process (28 days in total).

FIG. 43B depicts the fractions of As released from solids during aging.

FIG. 44 depicts the fractions of As(III) and As(V) released from ZVI corrosion products during the ageing process.

FIG. 45 depicts the mechanisms of As removal by MCCR and regulation by PUD.

### DETAILED DESCRIPTION OF THE INVENTION

The following detailed description is merely exemplary in nature and is not intended to limit the disclosure or its application and/or uses. It should be appreciated that a vast number of variations exist. The detailed description will enable those of ordinary skilled in the art to implement an exemplary embodiment of the present disclosure without undue experimentation, and it is understood that various changes or modifications may be made in the function and structure described in the exemplary embodiment without departing from the scope of the present disclosure as set forth in the appended claims.

The benefits, advantages, solutions to problems, and any element(s) that may cause any benefit, advantage, or solution to occur or become more pronounced are not to be construed as a critical, required, or essential features or elements of any or all of the claims. The invention is defined solely by the appended claims including any amendments made during the pendency of this application and all equivalents of those claims as issued.

Furthermore, as used herein, the term “about” or “approximately”, when used in conjunction with a numerical value or range of values, refers preferably to a range that is within 20 percent, preferably within 10 percent, or more preferably within 5 percent of a value with which the term is associated.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The terms “comprising,” “having,” and “including” or any other variation thereof, are to be construed as open-ended terms (i.e., meaning “including, but not limited to,”) unless otherwise noted. The use of any and all examples, or exemplary language (e.g., “such as”) provided herein, is intended merely to illuminate the invention better and does not pose a limitation on the scope of the invention unless otherwise claimed. No language in the specification should be construed as indicating any non-claimed element as essential to the practice of the invention.

Unless otherwise defined, all terms (including technical and scientific terms) used in the embodiments of the present invention have the same meaning as commonly understood by an ordinary skilled person in the art to which the present invention belongs.

In light of the background, it is desirable to provide a water treatment system that can sustainably and efficiently remove multiple small or dissolved contaminants from complex waters, providing safe and clean water to populations in need.

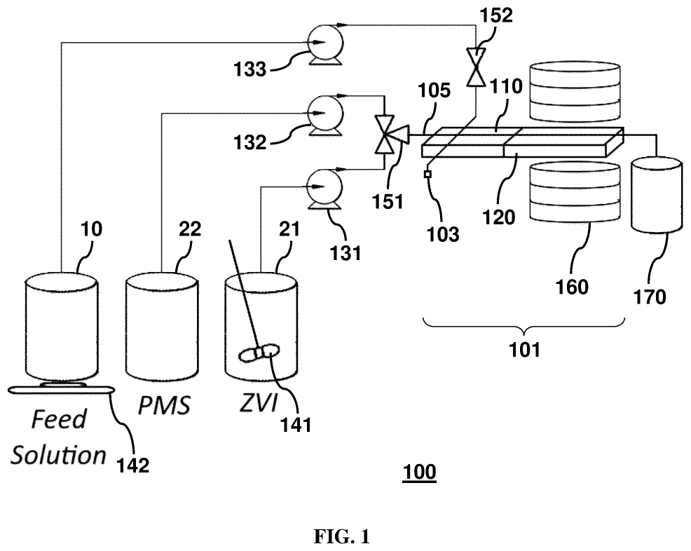

In accordance with the first embodiment of the present disclosure, a hollow fiber membrane chemical reactor (HF-MCR) 101 with sustainable and enhanced catalytic reactivity is provided, as shown in FIG. 1. The HF-MCR 101 employs a novel magnetic confinement strategy to realize unlimited, and efficient loading and, from time to time, reloading of the ZVI nanoparticles in the lumen of the hollow fiber membrane (HFM). The magnetically confined ZVI nanoparticles in the lumen are aligned to form a plurality of microwires comprising the ZVI nanoparticles (or referred to as “ZVI microwires”) in the magnetic field induced by a plurality of magnets 160. In certain embodiments, the plurality of magnets 160 may be a neodymium (NdFeB) magnet, a samarium-cobalt magnet, an Alnico magnet, a ferrite magnet, an electromagnet, or the like. The aligned arrays of ZVI microwires show superior hydrodynamic stability with a small release even at a very high flow velocity and cause little resistance to membrane separation.

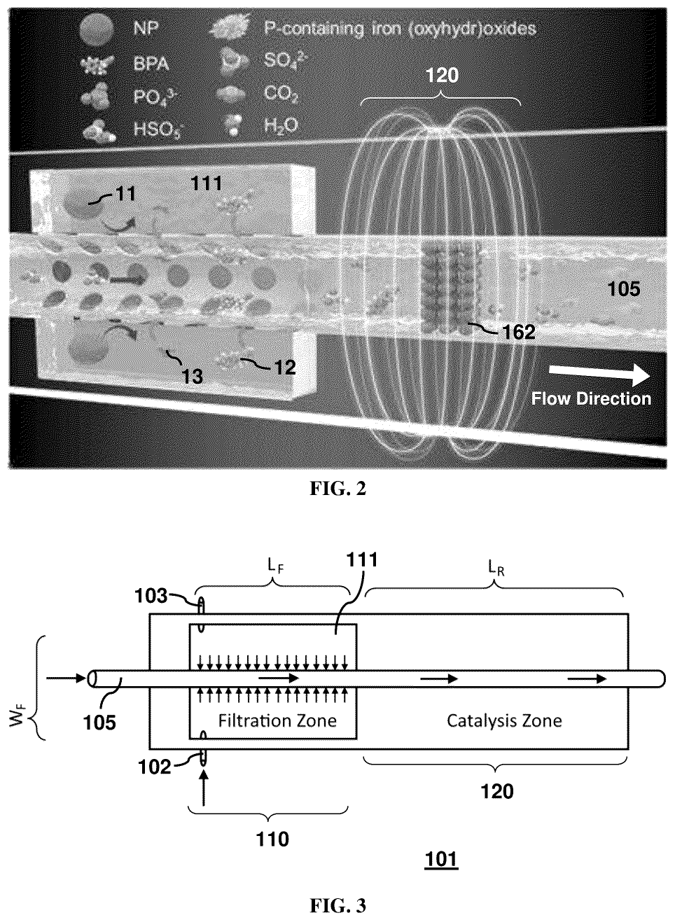

FIG. 2 provides an illustration of the removal of multiple contaminants from a solution injected into the filtration chamber 111, using a sequential combination of filtration and catalysis.

Particularly, the HF-MCR 101 uses one or more HFMs and magnetically confined Fenton-like catalysis for removing contaminants, including but not limited to nanoplastics (NPs) 11, BPA 12, and P-containing pollutants 13, which are frequently found in effluents of the wastewater treatment plant. In certain embodiments, other contaminants may be removed, including colloids, bisphenol F (BPF), bisphenol S (BPS), sulfamethoxazole (SMX), dichlorophenol (DCP), nitrophenol (NP), acetaminophen (APAP), trichloroacetic acid (TCAA), As containing pollutants, antimony (Sb) containing pollutants and the like. As the catalysis zone 120 is a magnetically confined zone, a plurality of microwires 162 comprising ZVI nanoparticles is formed in a lumen of the HFM 105. In certain embodiments, The NPs 11 are removed by size exclusion. The Fenton-like catalysis involves the use of a solution of peroxymonosulfate (PMS), peroxodisulfate, hydrogen peroxide with ZVI or ZVI-based materials, or dissolved O₂ or O₃ that is used to oxidize the contaminants, such as the BPA 12. The P-containing pollutants 13 are removed by chemical immobilization with in situ generated iron oxidation products of the Fenton-like catalysis. The simultaneous decontamination takes place in a continuous single-pass process with a hydraulic residence time of only a few seconds. Sustainable catalytic reactivity is achieved by both continuous surface depassivation and periodic reloading of ZVI nanoparticles in the magnetically confined zone. The present disclosure provides a HF-MCR 101 integrated with a novel magnetic confinement method for efficient catalyst loading or reloading to sustain a high catalytic reactivity, thereby the HF-MCR 101 can simultaneously and continuously decontaminate a complex water source.

Referring back to FIG. 1, the water treatment system 100 comprises the HF-MCR 101, and a magnetic field generator. The HF-MCR 101 comprises a filtration zone 110 at a frontend of the HF-MCR 101, and a catalysis zone 120 at a backend of the HF-MCR 101, which is shown in FIG. 3. The filtration zone 110 includes a filtration chamber 111, an inlet 102, and an outlet 103. In one embodiment, the filtration chamber 111 is housed with two needles that allowed solution to feed into the filtration chamber 111 (in dead-end filtration mode) or to be discharged from the filtration chamber 111 in backwashing mode for membrane washing. In certain embodiments, the filtration chamber 111 is filled with the feed solution 10 from the inlet 102. The feed solution 10 can permeate into the lumen of the HFM 105 and subsequently flow through the catalysis zone 120.

The catalysis zone 120 is a magnetically confined zone. In the catalysis zone 120, ZVI-based catalytic degradation and/or chemical immobilization can be initiated. In one experimental setup, the width W_{F} is 20 mm, the length L_{F} of the filtration zone 110 is 50 mm, and the length L_{R}of the catalysis zone 120 is 70 mm. An HFM 105 (or more than one HFMs) is disposed across the filtration zone 110 and the catalysis zone 120. The HFM 105 disposed across the catalysis zone 120 comprises ZVI nanoparticles.

In certain embodiments, the HFM 105 is a polytetrafluoroethylene (PTFE) membrane, a polyethersulfone (PES) membrane, a polyvinylidene fluoride (PVDF) membrane, or a ceramic membrane, with a membrane pore size ranges from 10 to 100 nm. The HFM 105 has an outer diameter of 1-16 mm and an inner diameter of 1-10 mm, preferably, the outer diameter is about 2.2 mm and the inner diameter is about 1.2 mm. The HFM 105, particularly the PTFE membrane, has excellent mechanical strength and chemical durability (e.g., resistance to chemical oxidation and acid-base corrosion), and a high water flux of 7000 L/(m² h bar).

The magnetic field generator is arranged to produce a magnetic field around the lumen of the HFM 105 at the catalysis zone 120 for realizing the magnetically confined zone that results in a formation of a plurality of microwires 162 comprising the ZVI nanoparticles in a lumen of the HFM 105. In particular, the ZVI nanoparticles are formed vertically to improve the hydrodynamic stability. The plurality of microwires 162 acts as a magnetic catalyst to enable catalytic degradation and chemical immobilization of the contaminant. In certain embodiments, the magnetic field has a magnetic flux density of 0.2 to 0.7 T, and preferably approximately 0.5 T. Throughout the specification of the present disclosure, ZVI nanoparticles or ZVI microparticles are used for the removal of contaminants. It is apparent to those skilled in the art that other materials may be used without departing from the scope and spirit of the present invention. In particular, the other materials include, but are not limited to, composite materials comprising ZVI, magnetite (Fe₃O₄), γ-Fe₂O₃, and other functional materials (catalytic, antimicrobial, etc., such as TiO₂, Pt, Pd, Au, etc.).

In the illustrated embodiment, the magnetic field generator is realized by a plurality of magnets 160. The HF-MCR 101 is sandwiched between the plurality of magnets 160 at the catalysis zone 120 with a gap of a predetermined thickness. The plurality of magnets 160 is a stack of eight cylindrical permanent magnets, each 50 mm in diameter and made of N40-N52 grade NdFeB. It is apparent that the shape and the number of permanent magnets may be otherwise without departing from the scope and spirit of the present disclosure. In one embodiment, four of the plurality of magnets 160 are positioned above the HF-MCR 101, and another four are positioned below the HF-MCR 101. The gap in the middle for inserting the HF-MCR 101 is 6 mm.

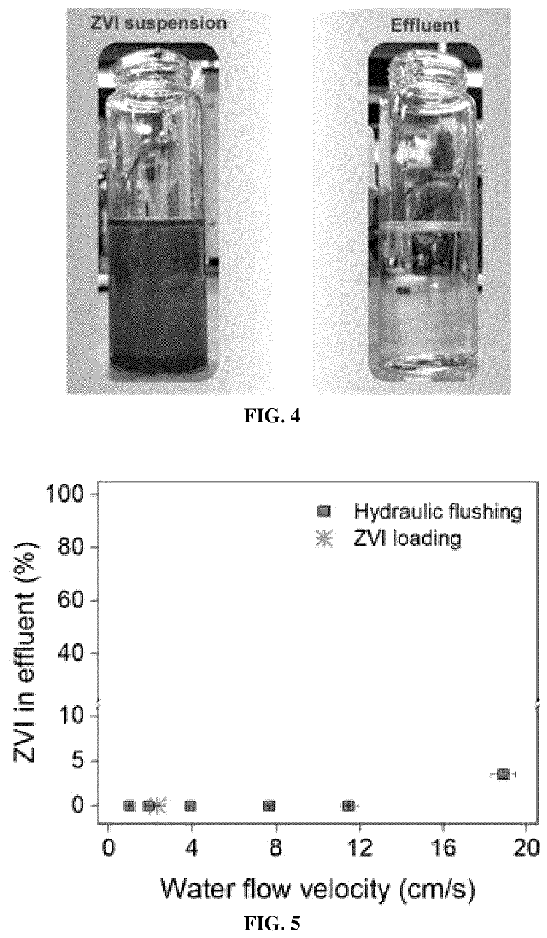

The water treatment system 100 further comprises a first pump 131 for loading and reloading the catalysis zone 120 with a ZVI suspension 21 comprising ZVI nanoparticles. FIG. 4 shows a photo of the ZVI suspension 21 used in the present disclosure. ZVI is one of the most common and most promising catalysts in water treatment. In a typical loading procedure, 15 mL of the ZVI suspension 21 having ZVI nanoparticles of a diameter ranging from 40-100 nm and 0.1-1.0 g/L is injected to the HFM 105 at a flow rate of 0.2-5 mL/min. Therefore, 15 mg of ZVI nanoparticles is first loaded into the catalysis zone 120. The ZVI suspension 21 is under mechanical stirring using a stirrer 141. The ZVI nanoparticles are rapidly captured and retained in the magnetically confined zone to form a plurality of microwires 162 comprising the ZVI nanoparticles in a lumen of the HFM 105. The ZVI loading mass can be adjusted by pumping different volumes of the ZVI suspension 21 into the HFM 105. After the ZVI suspension 21 passess through the catalysis zone 120, the ZVI is loaded and the photo of the effluent obtained is also shown in FIG. 4 to demonstrate the absence of ZVI.

After loading, the stability of the ZVI nanoparticles in the plurality of microwires 162 was tested under different hydrodynamic conditions (water flow velocities from 1.0 to 18.9 cm/s, corresponding water fluxes in the HFM 105 ranging from 111±8 to 2099±66 L/(m²h) (hereafter denoted as LMH). The cumulative effluent was collected for 10 min and digested by 1 M HCl for total Fe analysis. The aligned arrays of the plurality of microwires 162 show superior hydrodynamic stability (only a small release at a very high flow velocity of 18.9 cm/s) and cause little resistance to membrane separation. As shown in FIG. 5, the concentration of ZVI in the effluent 170 is measured and compared under different water flow rate for demonstrating the ZVI hydrodynamic stability after ZVI loading and before decontamination. The ZVI liberation is negligible, the ratio of released mass to loaded mass was <0.002% when the water flow velocity was below 11.5 cm/s. Even when the water flow velocity was increased to 18.9 cm/s, only 3.5% of ZVI was released into the effluent. When the water flow rate is less than 15 cm/s, the ZVI is basically undetectable in the effluent 170. Therefore, the high hydrodynamic stability of the plurality of microwires 162 of the ZVI nanoparticles makes the HF-MCR process feasible for water treatment.

The water treatment system 100 further comprises a second pump 132, and a third pump 133. The second pump 132 is arranged to inject an oxidant solution 22 into the HFM 105. A three-way valve 151 is optionally provided for selecting either an injection of the oxidant solution 22 or the ZVI suspension 21 into the HFM 105. Preferably, the oxidant solution 22 comprises PMS, peroxydisulfate, hydrogen peroxide with ZVI or ZVI-based materials, or dissolved O₂ or O₃. In one embodiment, the PMS has a concentration of 8 mM with an initial pH of 7.0. In the catalysis zone 120, the oxidant solution 22 is activated by the plurality of microwires 162 comprising the ZVI nanoparticles by an electron-transfer mechanism involving Fe²⁺ production and oxidation for producing reactive species. A magnetic field boosts ZVI corrosion via directional movement of paramagnetic Fe²⁺, primarily by magnetic gradient forces, thereby improving PMS activation to produce reactive species and iron (oxyhydr)oxides. In certain embodiments, the reactive species comprise 102, ·OH, and S₄ for performing the catalytic degradation of BPA 12 and in situ generated iron oxidation products involve goethite, lepidocrocite and ferrihydrite, for accounting for the chemical immobilization of P containing pollutants 13. A magnetic field simulation revealed that Fe²⁺ was prone to directionally migrate along the ZVI nanoparticle surface to its magnetic poles (i.e., physical contact points between the ZVI nanoparticles), driven by the increasing magnetic gradient forces.

The third pump 133 is arranged to inject the feed solution 10 containing contaminants into the to the filtration chamber 111 via an inlet 102. In certain embodiments, a magnetic stirrer 142 may be used to mix the multiple contaminants in the feed solution 10. In one embodiment, the feed solution 10 contains representative contaminants, including, 5 mg/L polystyrene NPs 11 (with an average diameter of 334±33 nm), 0.5 mg/L BPA 12, and 1 mg P/L H₂PO₄ (P-containing pollutants) 13. The water flux condition may be ranged from 122±3 to 476±15 LMH with an initial pH value of 7.0. A valve 152 is optionally provided for allowing or restricting the injection of the feed solution 10.

The filtration chamber 111 is filled with the feed solution 10 and establishes a fluid communication with the HFM 105 as means for communicating the feed solution 10 into the HFM 105 under an outside-in mode at the filtration zone 110. The HFM 105 has a membrane pore size of 10-100 nm, which can filter NPs 11 via size sieving. The feed solution 10, upon filtering nanoplastics (NPs) by the HFM 105 to obtain membrane permeate, is mixed with the oxidant solution 22 in the HFM 105 with a water flux ratio ranging from 10:1 to 100:1. The effluent 170 is obtained from the end of the HFM 105 after the sequential combination of filtration and catalysis.

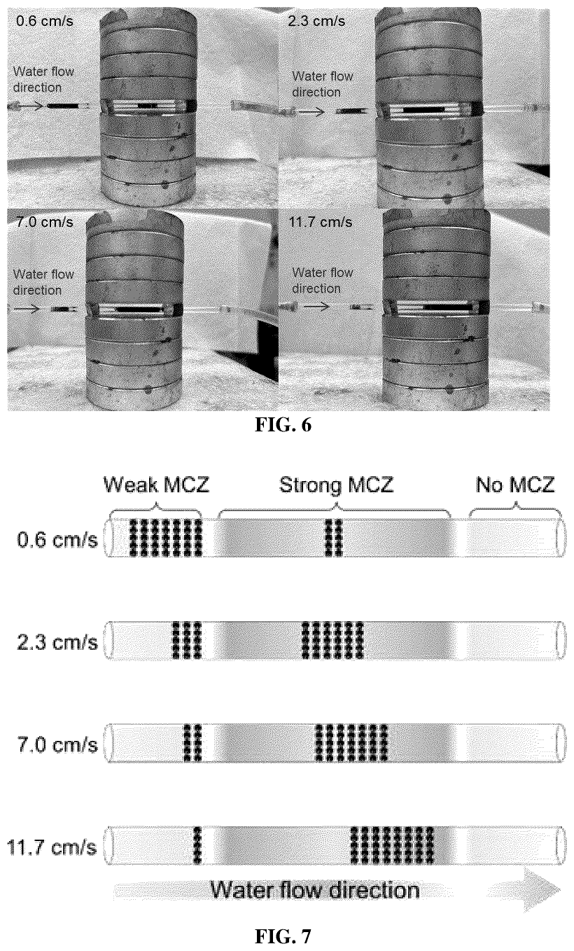

FIG. 6 and FIG. 7 show the experimental results regarding the effect of the water flow velocity on the distribution of the ZVI nanoparticles in the plurality of microwires 162. Visual microscopic observation further showed that ZVI nanoparticles was localized primarily in the strong magnetically confined zone (MCZ), with a few in the weak MCZ under the loading condition. The distribution of ZVI nanoparticles is highly dependent upon the water flow velocity. A higher water flow velocity moves ZVI nanoparticles further downstream, from the weak MCZ to the strong MCZ. Such a distribution pattern can be reasonably explained by our magnetic field simulation.

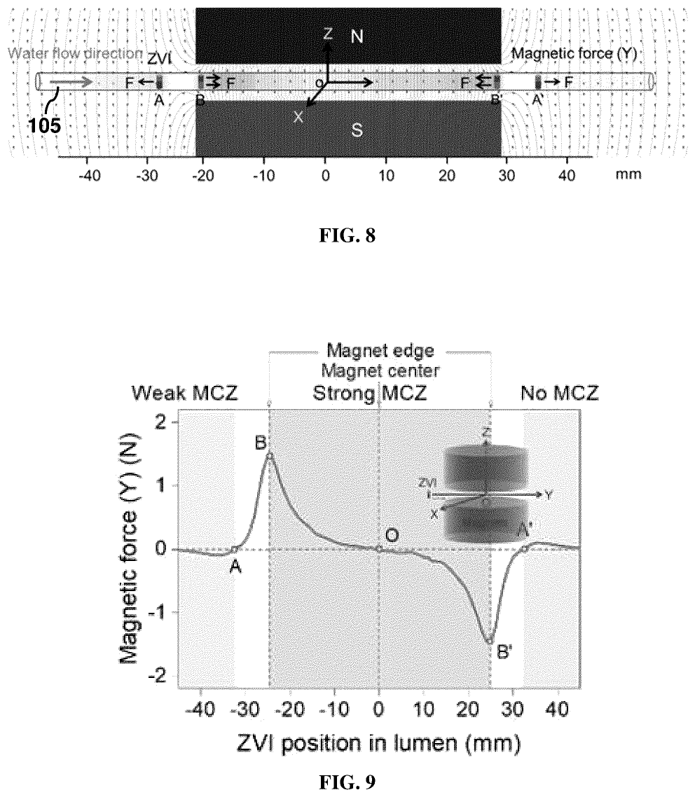

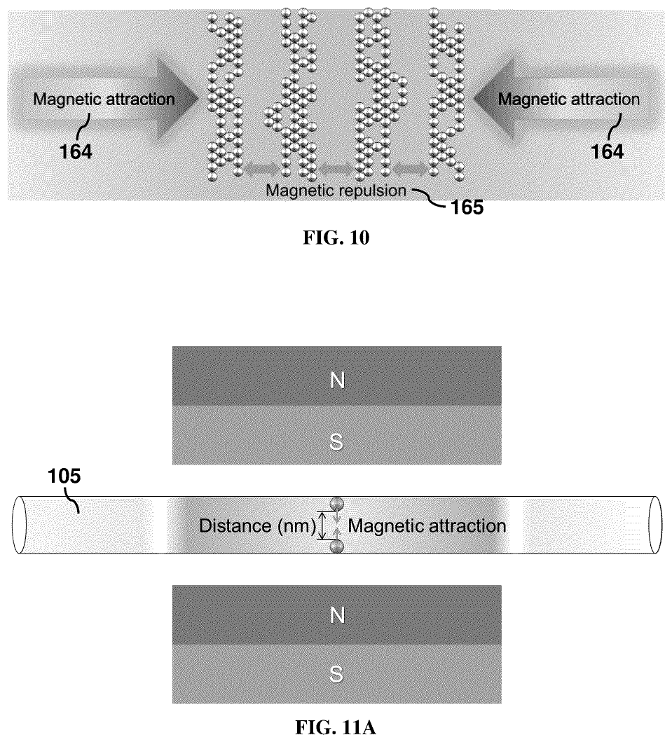

FIG. 8 shows the magnetic force acting on a magnetized ZVI rod along the water flow direction (Y axis) for simulating a microwire in the magnetic field. FIG. 9 shows the simulated magnetic force acting on a ZVI rod (2 mm×5 mm, D×L) along the Y axis in the magnetic field. The Y axis is the water flow direction along the HFM 105, while the magnetic field is oriented perpendicular to the water flow direction. The magnetically confined zone attributes to a distribution pattern of the magnetic force along the Y-axis. As shown in FIG. 10, there is a magnetic attraction force 164 and a magnetic repulsion force 165 acting on the ZVI nanoparticles, thus leading to the formation of the plurality of microwires 162 in the lumen of the HFM 105. The formation of the plurality of microwires 162 is attributed to the magnetic confinement. The magnetization of the ZVI nanoparticles primarily along the Z axis (or the magnetic induction line) that creates a much-enhanced magnetic attraction force (0.0035 N) between two ZVI nanoparticles to form the microwires, then the magnetic repulsion force between the microwires in the X-Y plane to maintain the interspace. The plurality of microwires 162 evenly filled the cross-section of the lumen on the X-Z plane due to the uniform magnetic field. The plurality of microwires 162 does not form large compact agglomerates, but rather having interspaces between plurality of microwires 162 that could be regulated by the water flow velocity and loading mass as well as magnetic field. With the plurality of microwires 162, a low water channel resistance and a large exposed surface area of ZVI are achieved. An efficient mass transfer can therefore contribute to highly efficient catalytic decontamination under a small head loss.

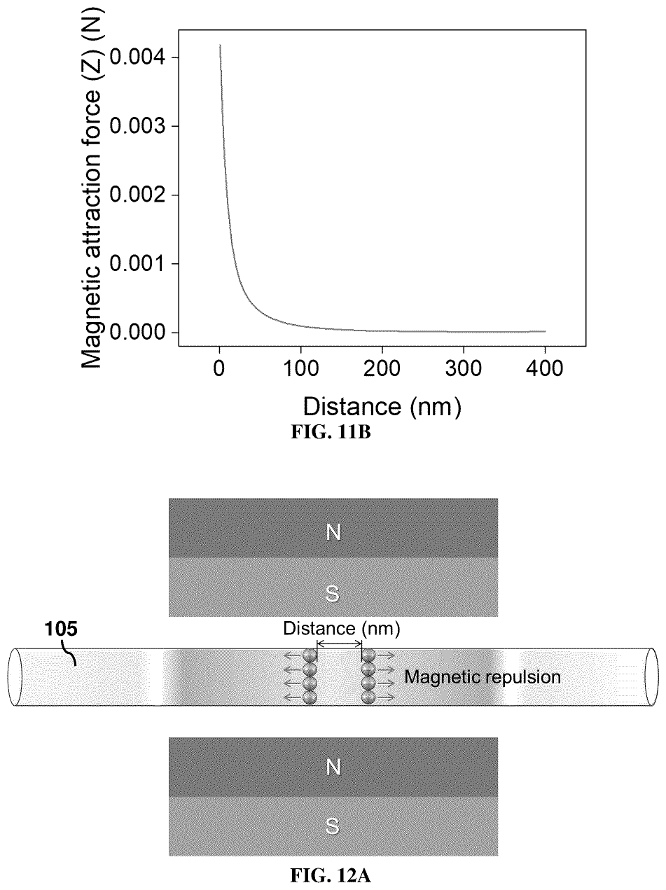

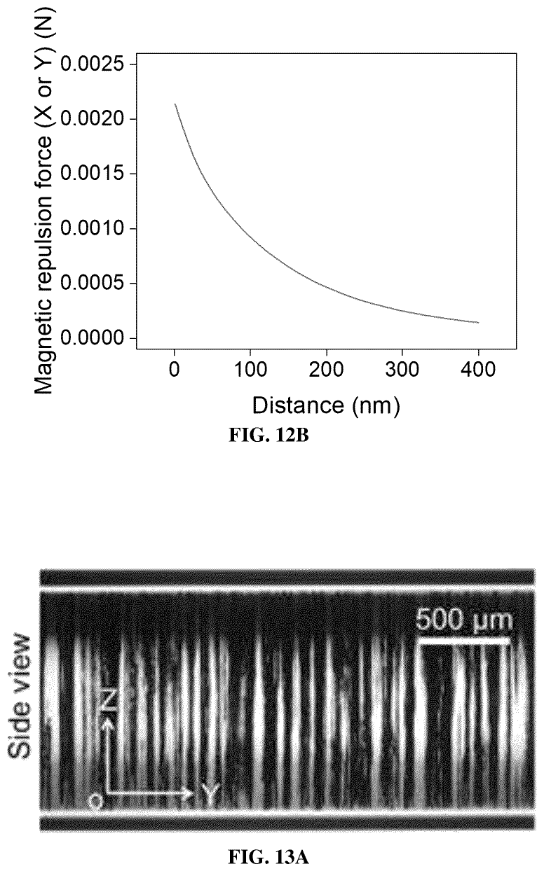

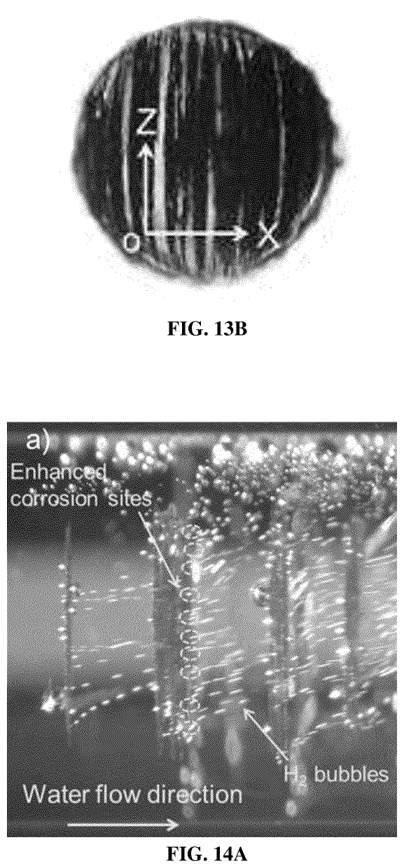

In further details, with reference to FIGS. 11A and 11B, the vertical formation along the Z axis of the plurality of microwires 162 of ZVI by magnetic attraction force in the magnetic field is shown. The change in magnetic attraction force is reduced as the distance between the ZVI nanoparticles increases. With reference to FIGS. 12A and 12B, the interspace formation along the X-Y plane of the plurality of microwires 162 of ZVI by magnetic repulsion force in the magnetic field is shown. The change in magnetic repulsion force is reduced as the distance between the ZVI nanoparticles increases. FIGS. 13A and 13B show the photographs of the plurality of microwires 162 magnetically confined with ZVI in the lumen of the HFM 105 along the Z-Y plane and the Z-X plane respectively.

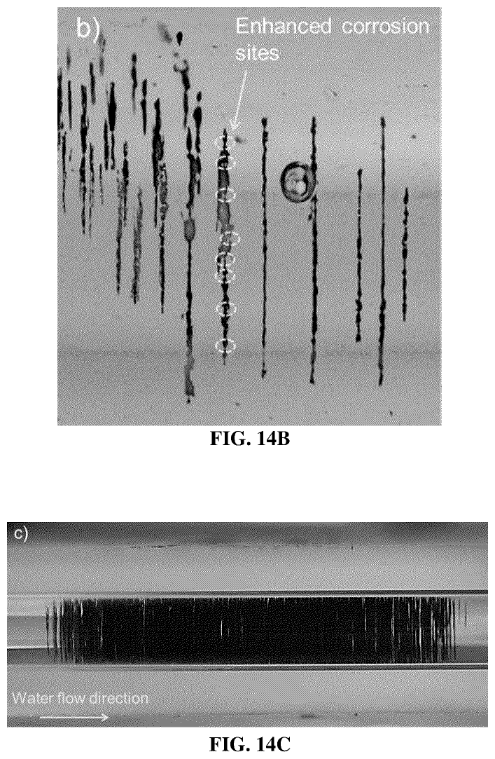

The plurality of microwires 162 exhibits a reciprocating movement in the lumen of the fiber tube 105 due to the combined effects of the hydrodynamic stress and the inward magnetic forces along the water flow direction. The movement is further strengthened and accelerated when the cumulative effluent volume increased, due to weakened magnetic forces along the water flow direction acting on the corroded microwires. The movement favors the continuous production of reactive species and iron (oxyhydr)oxides by constantly depassivating and exposing fresh ZVI to PMS. Thus, each ZVI nanoparticle experiences boosted corrosion near its magnetic poles, as implied by the dissolution of the plurality of microwires 162 by HCl. FIGS. 14A-14B show the dynamic dissolution and partial residues of the pluralty of microwires 162 after HCl treatment in the magnetic field. In principle, the ZVI microwires in the X-Y plane have equal opportunities to activate PMS for the production of RS and iron (oxyhydr)oxides (to remove BPA and P). FIG. 14C shows the spatially uniform decolorization of Rhodamine B in the HF-MCR 101. Such repeated corrosion eventually resulted in shorter and thinner ZVI or even the disappearance of ZVI in the plurality of microwires 162.

In one experimental setup for analyzing the sequential combination of filtration and catalysis (FC mode), 20 mL of the effluent 170 was sampled at each effluent volume interval of 58 L/m². The test was stopped once the P concentration in the effluent 170 was equal to or higher than 0.5 mg P/L, which is the discharge limit for P from municipal wastewater treatment plant (WWTP) in China (Grade I-A, GB 18918-2002). To analyze the BPA concentration, 2 mL of subsample was taken from 20 mL of the effluent 170 and immediately mixed with 0.05 mL of 1 M Na₂S₂O₃ solution to quench further reactions between BPA and the reactive species. The rest of the sample was used for other analyses (e.g., NPs, P, and pH). As control experiments, only filtration mode (F mode) and only catalysis mode (C mode) were conducted under the same experimental conditions. Specifically, the same procedure was followed in F mode but the PMS-free solution was fed in the absence of ZVI. For the C mode, the feed solution was mixed with the PMS solution and directly flowed through the lumen into the catalysis zone loaded with ZVI.

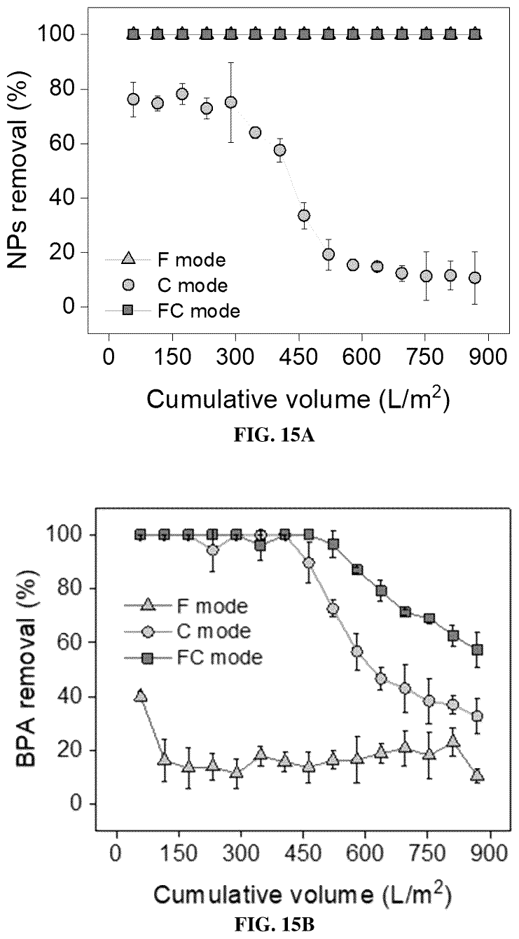

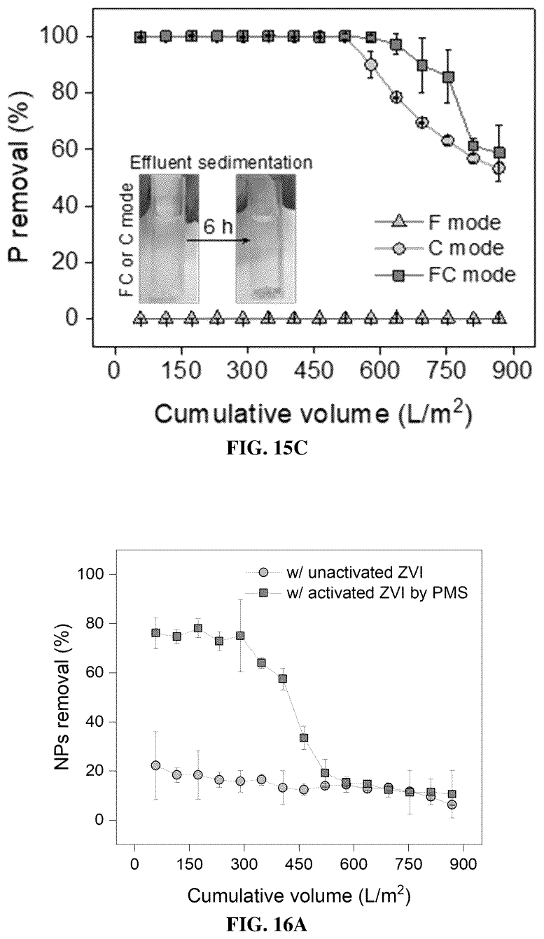

The control experiments with F mode and C mode demonstrated a lower removal of the three model pollutants, particularly in the middle-late stage. As shown in FIG. 15A, both F mode and FC mode can achieve 100% removal of the NPs 11, but C mode is less than satisfactory. The NPs 11 removal dropped from 78% to 10%, as the cumulative effluent volume increased. Although F mode can completely remove NPs 11, as shown in FIG. 15B, the BPA 12 removal decreased from 40% to 10%. The BPA 12 removal can be ascribed to adsorption of BPA 12 onto the NPs 11, which were subsequently intercepted by the membrane, as well as adsorbed onto the HFM 105. Referring to FIG. 15C, negligible P-containing pollutants 13 removal (<0.02%) was observed in F mode without ZVI loading. Even when the HFM 105 was loaded with unactivated ZVI, removal of P-containing pollutants 13 was dropped sharply from 62% to 3% in the initial stage as the limited amount of iron (oxyhydr)oxides produced on the ZVI surface during storage captured a small amount of P-containing pollutants 13 only. In addition, within a hydraulic residence time of only 1.4 s, there was negligible iron (oxyhydr)oxides production due to little ZVI corrosion by dissolved O₂.

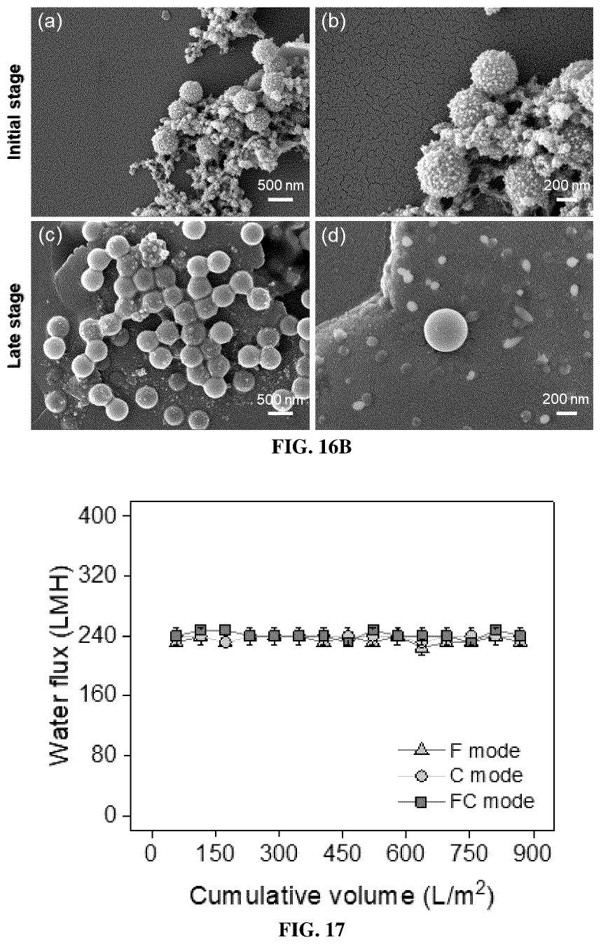

Referring to FIG. 16A, considering the low NPs 11 removal in the presence of unactivated ZVI (generally below 22%), enhanced NPs 11 removal can be ascribed to co-sedimentation with in situ generated iron (oxyhydr)oxides, via electrostatic attraction and/or complexation. Such co-sedimentation is further confirmed by the iron (oxyhydr)oxides coating on the NPs surface, as shown in the Field Emission Scanning Electron Microscopy (FE-SEM) images of FIG. 16B. In the initial-middle stage, a thicker coating of the iron (oxy)hydroxides on the NPs 11 surface was observed as the cumulative effluent volume increased. Afterward, however, the iron (oxyhydr)oxides coating on the NPs 11 surface decreased or even disappeared due to ZVI exhaustion. The late-stage images can demonstrate this finding. Accordingly, poor NPs 11 removal was also observed in FIG. 15A. In C mode, BPA 12 and P-containing pollutants 13 were completely removed in the initial-middle stage. With the loss of active catalytic sites (i.e., Fe⁰ and Fe^{II}) toward PMS activation, their removal finally dropped to 32% and 53%. It is noteworthy that there is a lower removal of NPs 11, BPA 12, and P-containing pollutants 13 in C mode, particularly in the middle-late stage, compared with that in FC mode. NPs 11 with abundant functional groups (e.g., oxygen-containing groups) can scavenge in situ generated reactive species (e.g., ¹O₂, SO₄^{·-}, and ·OH) and thus impede the BPA degradation.27 In turn, NPs 11 attacked by reactive species can further create competitive sites (e.g., oxygen-containing groups) that can bind with iron (oxyhydr)oxides, thus deteriorating the P-containing pollutants 13 removal. Among the three modes, at a cumulative effluent volume of 752 L/m², BPA 12 and P-containing pollutants 13 removals (79% and 86%, respectively) in FC mode are impressively higher than the sum of their separate removals in the two other modes (65% and 63%). This comparison suggests that the sequential filtration and reactions synergistically remove BPA 12 and P-containing pollutants 13, benefiting from the full NPs removal in advance, similar to the enhancement enabled by advance removal of natural organic matter in MCR.

FIG. 17 shows that the HF-MCR 101 in FC mode exhibited a stable water flux of 241±3 LMH throughout the test, close to that in F mode or C mode. This finding indicates not only that the plurality of microwires 162 formed by magnetically confined ZVI in the lumen causes little water channel resistance, but also that HFM fouling is negligible, possibly because of poor interaction between the PTFE-based HFM and NPs. The above results together highlight the utilization and synergy of multiple decontamination mechanisms in achieving a high-performance HF-MCR 101.

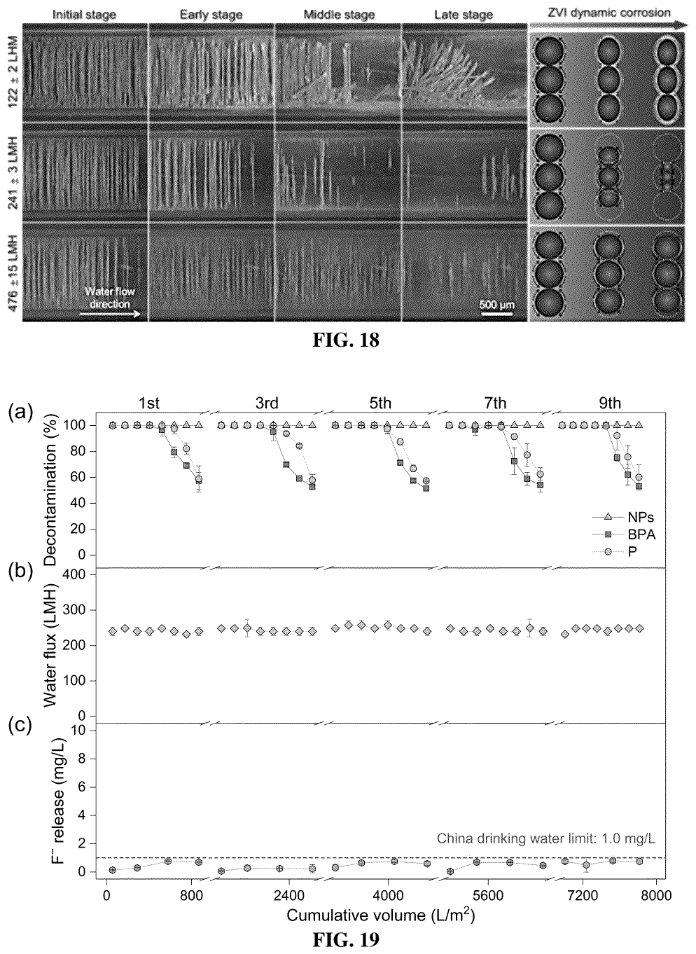

The dynamics of the ZVI corrosion were visualized to elucidate the water flux-induced differences in BPA and P removal. FIG. 18 shows that the plurality of microwires 162 were corroded by PMS more slowly in the initial stage when the water flux was increased from 122±2 to 241±3 LMH. The observation is indicated by the lesser and slower growth of brown swelled iron (oxyhydr)oxides film on their surface, the result of larger hydrodynamic stress and a shorter residence time. The higher effluent pH at this stage also indicated less PMS activation by ZVI. However, as the tests proceeded, the iron (oxyhydr)oxides film on the surface of the plurality of microwires 162 grew further, significantly impeding PMS activation by the fresh ZVI core and resulting in a higher effluent pH. At a higher water flux of 241±3 LMH, the plurality of microwires 162 exhibited stronger and accelerated reciprocating movement, forming a smaller and thinner iron (oxyhydr)oxides film that allowed continuous exposure of fresh iron core to PMS. This condition favored continuous activation of PMS by the plurality of microwires 162, resulting in higher BPA12 removal and P-containing pollutants 13 removal by iron (oxyhydr)oxides.

An intermediate water flux of 241±3 LMH was found to be most effective for simultaneous decontamination. At higher water fluxes, such as 476±15 LMH, the hydraulic residence time was very limited, resulting in significantly reduced reactive species and iron (oxyhydr)oxides production, lower BPA 12 and P-containing pollutants 13 removal, and higher effluent pH. Negligible membrane fouling by NPs 11 was observed over the entire course of the operation. In summary, water flux affects not only the contact time between the plurality of microwires 162 and PMS but also the surface depassivation (or reactivity) of the plurality of microwires 162, which collectively determine the production of reactive species and iron (oxyhydr)oxides for the removals of BPA 12 and P-containing pollutants 13.

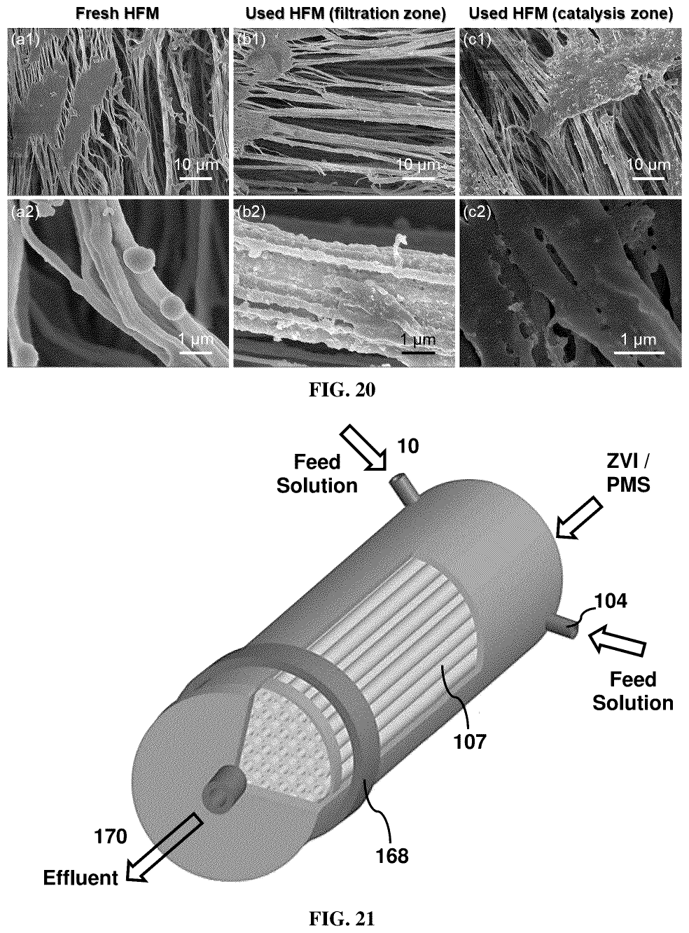

While the HF-MCR 101 can maintain high reactivity toward PMS activation by continuous depassivation, the loaded ZVI is inevitably exhausted and can no longer provide satisfactory BPA 12 and P-containing pollutants 13 removal. To renew reactivity, catalysts are generally reloaded into a magnetically confined zone, with periodic membrane washing and ZVI reloading. FIG. 19 shows that NPs removal remained at 100% over the course of each test, and the water flux remained stable (˜241 LMH). These observations indicate that the HF-MCR preserves its membrane pore integrity over the 9-cycle operation. FIG. 20 shows the FE-SEM images of the interior surface of a new HFM (a1,a2), a used HFM from the filtration zone 110 (b1,b2), and a used HFM from the catalysis zone 120 (c1,c2) after 9 cycles of test. There is no observable structural damage by PMS attack and/or ultrasonication to wash the membrane. Furthermore, F-release from the PTFE-based HFM 105 remained below the recommended drinking water limit (1 mg/L), which can be observed from FIG. 19. This low level is the result of not only the relatively inert nature of the PTFE material but also the spatial configuration of the HF-MCR 101. the membrane structure of the filtration zone 110 is fully protected from being attacked by strongly oxidizing reactive species, particularly SO₄^{·-} and ·OH. In each of the 9 runs, the BPA 12 and P-containing pollutants 13 removal decreased gradually from 100% to −53% and −59%, respectively. This indicates a stable and high decontamination performance. In summary, the HF-MCR 101 of the present disclosure, using magnetically confined catalyst loading and reloading, offers high and sustainable catalytic reactivity for decontamination. The performance is far superior to that of many other reported MCRs, which suffer from catalyst depletion and cannot be reloaded.

FIG. 21 depicts a schematic showing possible scale-up of the HF-MCR 101. In the scale-up version, the water treatment system 100 comprises HF-MCR 101 housing one or more HFMs 107 or ceramic membranes within. The one or more HFMs 107 is similar to a bundle of HFM 105 discuss above. The filtration chamber 111 receives the feed solution from one or more inlets 104 to maximize the water flow rate. As the one or more HFMs 107 or the ceramic membranes are housed in a cylinder, it is advantageous to provide a magnetic field generator that can surround the one or more HFMs 107 for producing a magnetic field. In certain embodiments, the magnetic field generator comprises a plurality of magnets forming a diametrically magnetized ring magnet 168 arranged to surround the one or more HFMs 107.

In accordance with the second embodiment of the present disclosure, the magnetic field generator with ZVI can also be used for groundwater treatment at households in areas affected by arsenicosis, but afford limited arsenic (As) removal performance and water treatment capacity. The use of a parallel magnetic field in the HF-MCR 101 of the first embodiment can significantly enhance the removal of contaminants by forcing ZVI oxidative corrosion. Under the parallel magnetic field, ZVI nanoparticles formed a plurality of microwires 162 with ultrahigh hydrodynamic stability. Such demonstration of the HF-MCR 101 motivates the development of the following second embodiment of a ZVI-based flow-through column with parallel magnetic fields for the As removal at the household level.

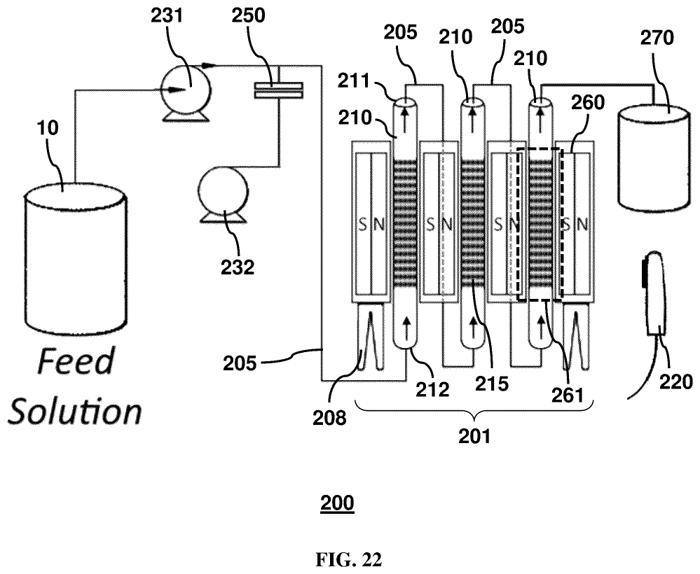

In accordance with the second embodiment of the present disclosure, a water treatment system 200 having a magnetic confinement-enabled column reactor (MCCR) 201 for As removal is provided, as shown in FIG. 22. The MCCR 201 is a flow-through reactor that employs ZVI microparticles to realize efficient and sustainable As removal by continuously generated iron (oxyhydr)oxides from ZVI oxidative corrosion. The As contamination in drinking water is a major global concern. Existing methods, like sand filters with ZVI, have limitations such as channel clogging and loss of reactivity due to passivation of ZVI. The MCCR 201 and the accompanying periodic ultrasonic depassivation (PUD) provide a novel system for efficient and sustainable removal of As from the feed solution 10, while the ZVI reactivity is maintained. The hydrodynamic stability is significantly improved, and clogging is prevented.

The water treatment system 200 includes the MCCR 201 and an ultrasonic generator 220. The ultrasonic generator 220 is used to realize the PUD for maintaining the ZVI reactivity. The MCCR 201 further comprises one or more column filters 210 oriented along a vertical direction; and a magnetic field generator. As shown in the illustrated embodiments, there are three column filters 210 arranged vertically and parallel to each other. Each column filter 210 has a length of 5-15 cm and an inner diameter of 0.5-2 cm. It is apparent that the number of column filters may be otherwise without departing from the scope and spirit of the present disclosure. If there are more column filters, the effectiveness of the removal of As is expected to be more superior. If there is only one column filter, the performance of the MCCR 201 may be less than satisfactory unless the column filter is much longer in length. The described configuration is one possible implementation verified by experiments, while other configurations with simple and obvious adjustment may be implemented. Each of the one or more column filters 210 is filled with microscale ZVI.

The magnetic field generator is arranged to produce a magnetic field around the one or more column filters 210 for realizing a magnetically confined zone 261 that results in a formation of a plurality of ZVI wires 215 comprising ZVI microparticles within the one or more column filters 210 for reducing aqueous As (As_{aq}) concentration in the feed solution 10 after the feed solution 10 is pumped through the one or more column filters 210. With the MCCR 201, the ZVI microparticles are self-assembled into a plurality of ZVI wires 215, which are parallel millimeter-scale wires in the strong magnetic field. In certain embodiments, the magnetic field has a magnetic flux density of 0.3 to 0.6 T, and preferably in the range of 0.42 to 0.48 T. The magnetic field generator contributes to the formation of a highly porous reactor with 87% of porosity and a doubled accessible/reactive surface area that of a sand/ZVI filter. With a feed concentration of 100 pug/L As(III), the breakthrough volume (>10 μg/L) of the MCCR 201 with PUD was 7338 empty bed volume (EBV), 9.36 times higher than that of the sand filter.

In certain embodiments, the magnetic field generator comprises a plurality of magnets 260 sandwiching the MCCR 201. The plurality of magnets 260 may be a N52 grade NdFeB magnet, a samarium-cobalt magnet, an Alnico magnet, a ferrite magnet, an electromagnet, or the like. In certain embodiments, the one or more column filters 210 and the plurality of magnets 260 are assembled in a customized acrylic frame 208. Advantageously, the plurality of magnets 260 and the one or more column filters 210 are arranged in an interleaving manner, and each of the one or more column filters 210 is sandwiched by two of the plurality of magnets 260.

In the illustrated embodiments, there are three column filters 210 arranged in parallel at the same vertical position. In order to provide the magnetic field around them, there are four magnets 260 vertically placed next to the three column filters 210. Each of the plurality of magnets 260 has a length of 7-17 cm, width of 4-6 cm, and thickness of 1-3 cm. The first column filter is sandwiched by the first magnet and the second magnet; the second column filter is sandwiched by the second magnet and the third magnet; and the third column filter is sandwiched by the third magnet and the fourth magnet. The one or more column filters 210 and plurality of magnets 260 are vertically placed inside the customized acrylic frame 208 in a face-to-face stacked fashion, with a gap of 1-3 cm between two adjacent magnets. In this scenario, a substantially parallel magnetic field with a magnetic flux density of 0.42-0.48 T along the thickness direction of the magnets is generated. Each of the one or more column filters 210 is inserted in the middle of the gap along the length direction of the plurality of magnets 260. The one or more column filters 210 are connected with pipelines 205 in tandem that can allow the feed solution 10 to flow through in a bottom-up flow direction. After passing through the one or more column filters 210, the effluent 270 is obtainable from the last column filter.

In greater detail, each of the one or more column filters 210 comprises an upper outlet 211 and a lower inlet 212 for allowing the feed solution to flow in a bottom-up flow direction. The peristaltic pump 231 is arranged to inject the feed solution 10 with the As-containing material into the to the one or more column filters 210 of the MCCR 201 via the lower inlet 212. In certain embodiments, the As-containing material includes NaAsO₂ and/or Na₂HAsO₄·7H₂O.

The water treatment system 200 further includes an air pump 232 and a hydrophobic filter 250. The hydrophobic filter 250 is configured to prevent water from the feed solution 10 from passing through, while allowing the air pump 232 to inject air into the feed solution 10 for improving dissolved oxygen (DO) concentration.

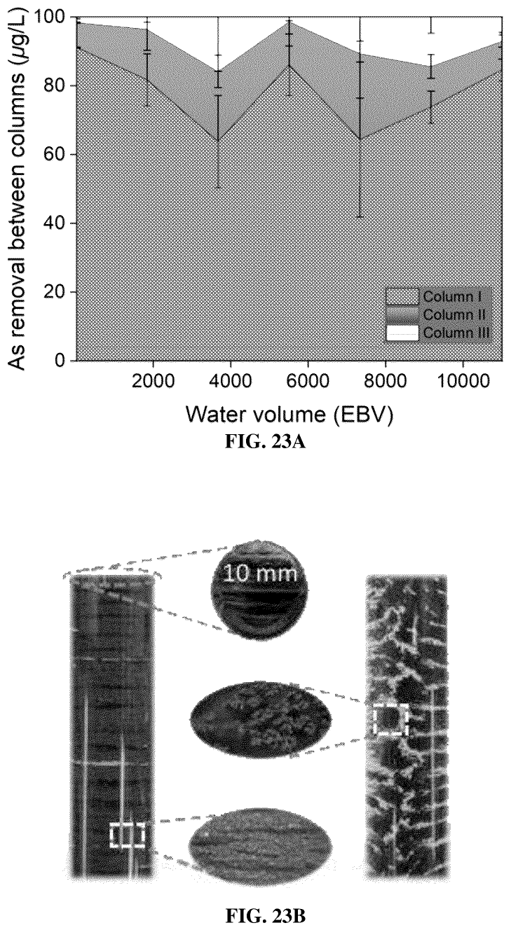

Considering that the three column filters comprise a first column filter, a second column filter, and a third column filter, all arranged in parallel to each other. The feed solution 10 is pumped into the lower inlet 212 of the first column filter. The first column filter is in fluid communication with the second column filter by connecting a pipeline 205 from the upper outlet 211 of the first column filter to the lower inlet 212 of the second column filter. Similarly, the second column filter is in fluid communication with the third column filter by connecting another pipeline 205 from the upper outlet 211 of the second column filter to the lower inlet 212 of the third column filter. As demonstrated in FIG. 23A, although the three column filters 210 are all responsible for the As removal, the first column filter has a significantly higher contribution to the removal of As (within an hydraulic retention time (HRT) of 31.4 seconds).

FIG. 23B shows the photos of the plurality of ZVI wires 215 formed inside the one or more column filters 210. As each of the one or more column filters 210 is filled with microscale ZVI, when the one or more column filters 210 are placed within the magnetically confined zone 261, the plurality of ZVI wires 215 are formed. Unlike tedious loading of ZVI into a sand filter, the MCCR 201 allows much more efficient and facile loading of ZVI microparticles. Particularly, the ZVI microparticles spontaneously formed the plurality of ZVI wires 215 by the parallel magnetic field, and the plurality of ZVI wires 215 are evenly dispersed because of the uniform magnetic field. Compared with the conventional sand filter, there is more available space between the plurality of ZVI wires 215 in the MCCR 201, resulting in a lower water channel resistance.

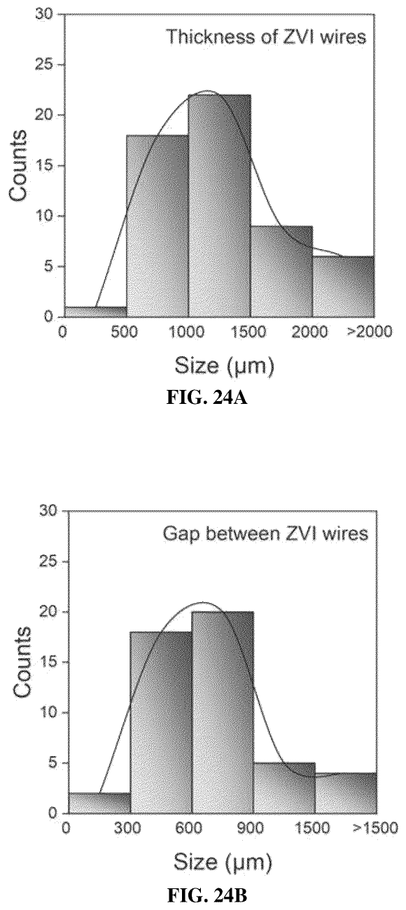

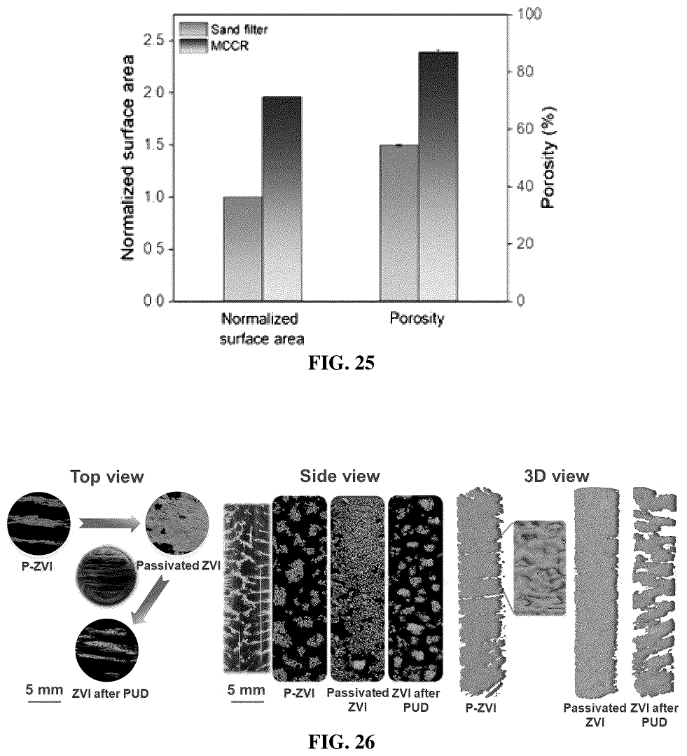

As shown in FIG. 24A and FIG. 24B, the gap between the plurality of ZVI wires 215 is 773±497 μm on average. The average thickness of the plurality of ZVI wires 215 is 1267±606 μm. The structure is attributed to magnetic confinement, which is based on the same principle as discussed above in the first embodiment. On one hand, the ZVI microparticles are magnetized along the direction of the magnetic induction lines to be “micromagnets”, so that enhanced magnetic attraction forces between the “micromagnets” are created to form the plurality of ZVI wires 215. On the other hand, there were magnetic repulsion forces between the plurality of ZVI wires 215, which results in the interspace among the millimeter-scale wires. In particular, the plurality of ZVI wires 215 can be assembled by ZVI particles with abundant voids, thus causing more accessible surface of ZVI towards reactants (e.g., As and O₂), as indicated by almost two-folds phosphate adsorption capacity than that of sand filters, this is illustrated in FIG. 25.

Furthermore, the plurality of ZVI wires 215 has a higher porosity (0.87±0.01), as compared with the packed sand/ZVI mixture (0.54±0.00). The porosity of the plurality of ZVI wires 215 is 1.61 folds that of the ZVI/sand filter. The structure of the ZVI array in the plurality of ZVI wires 215 is further characterized by micro-computed tomography (micro-CT), as shown in FIG. 26. The pristine ZVI wires are uniformly dispersed with large interspace as observed from top and side views. The abundant micro-voids in the microstructure of the plurality of ZVI wires 215 are confirmed. The structure of the plurality of ZVI wires 215 after reaction and after PUD are also captured using micro-CT to show the difference.

The hydrodynamic stability of ZVI is a prerequisite for a flow-through reactor. Therefore, physical release (i.e., no chemical dissolution/corrosion) of ZVI was tested at water flow velocities from 0.5 to 4.8 cm/s (or the water flow rates from 23.1 to 207.7 mL/min). FIG. 27 shows that the ZVI in the effluent is negligible at the entire range of water flow velocities. Such high hydrodynamic stability has been verified even at 11.5 cm/s in the HF-MCR 101 of the first embodiment of the present disclosure due to the enhanced magnetic force acting on the plurality of microwires 162 over individual ZVI microparticles. To summarize, this result demonstrates an excellent dispersion of the ZVI microparticles in the MCCR 201, forming the plurality of ZVI wires 215 comprising ZVI microparticles in the magnetic field. The high exposed surface area and porous structure of the ZVI wires are expected to enhance the As removal efficiency.

The water treatment system 200 addresses the issue of ZVI passivation by implementing PUD with the ultrasonic generator 220. In one possible implementation, the ultrasonic generator 220 is a portable ultrasonic probe. The ultrasonic generator 220 is coupled to the one or more column filters 210 and is capable of periodically applying ultrasonic energy to the plurality of ZVI wires 215 to sustain reactivity. Particularly, the ultrasonic generator 220 is configured to be activated, from time to time, to apply the ultrasonic energy to the one or more column filters 210 to prevent surface passivation of the ZVI microparticles in the plurality of ZVI wires 215. It is apparent that the ultrasonic generator 220 may be housed within or mounted on the customized acrylic frame 208 and programmed to be activated regularly. Each time the ultrasonic generator 220 is activated regularly for approximately 1 minute or more, based on a PUD frequency. The PUD frequency may range from 2 hours to 24 hours, and preferably, the PUD frequency is 6 hours to 12 hours. The ultrasonic generator 220 is configured to apply the ultrasonic energy to the one or more column filters 210 at the same time, individually, or dynamically depending on the volume of the feed solution 10 passing through the MCCR 201. The ultrasonic generator 220 has an ultrasonic frequency ranging from 40 kHz to 100 kHz. With the use of the ultrasonic generator 220, the surface passivation of the ZVI microparticles in the plurality of ZVI wires 215 is eliminated by polishing the surface. Therefore, the ZVI reactivity can be sustained.

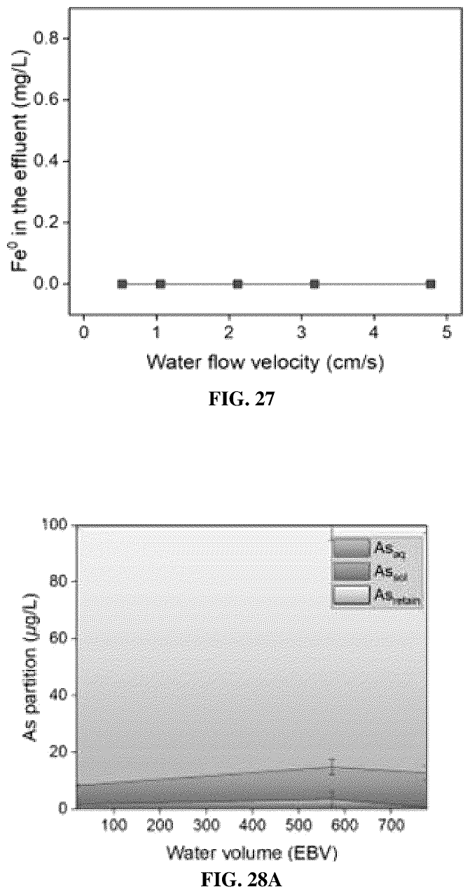

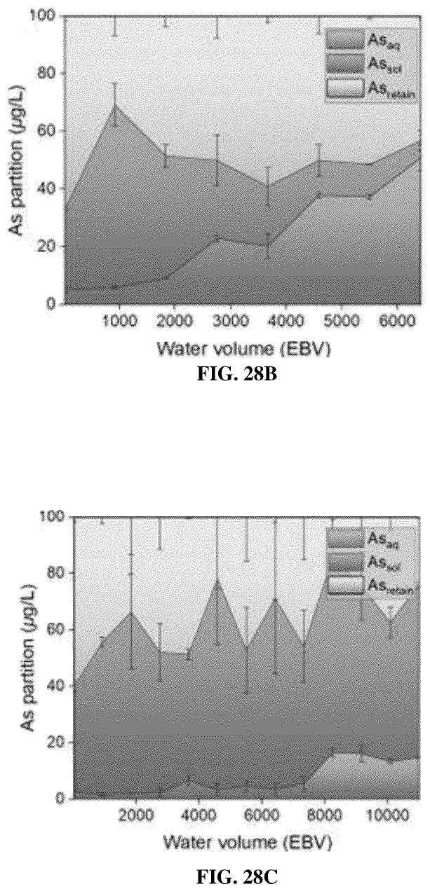

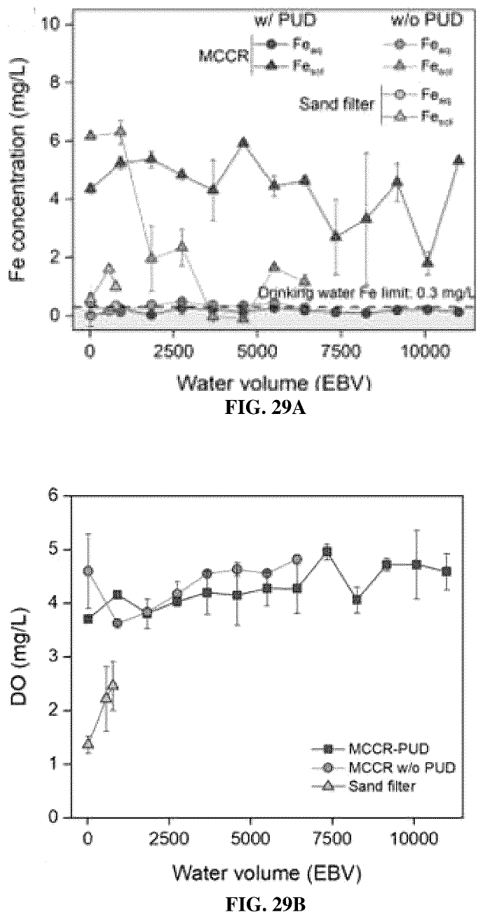

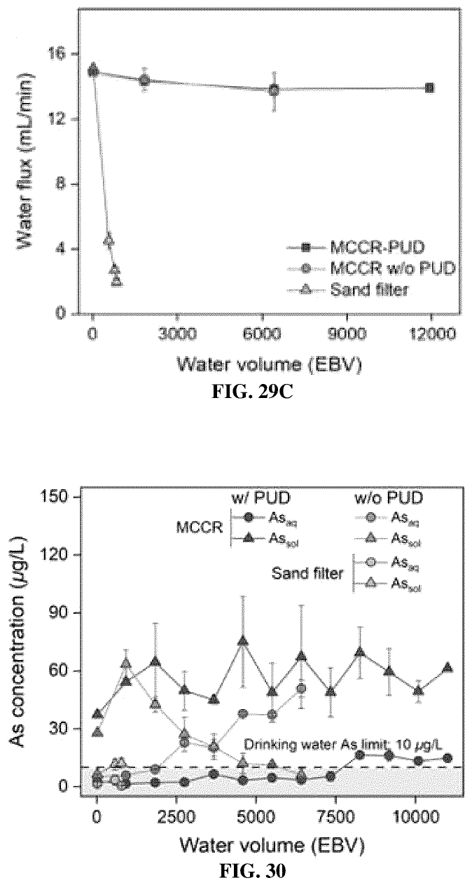

With reference to FIG. 28A for sand filter, and FIG. 28B for MCCR 201 without PUD, during the first 48 hours, the concentrations of aqueous As (As_{aq}) in the effluent 270 are maintained below 10 pug/L because of the initial high reactivity of ZVI. However, as shown in FIG. 30, the concentration of solid-phase As (Assoi) in the effluent 270 from the MCCR 201 without PUD is significantly higher than that from the sand filter, which is due to higher production of As-bearing iron-based corrosion products and their subsequent transport out of the column. The relatively high amounts of corrosion products in the effluent from the MCCR 201 without PUD contributes to the fast corrosion of ZVI due to its higher reactivity in the magnetic field. Although the interspace of the plurality of ZVI wires 215 in the MCCR 201 without PUD was filled with corrosion products after passivation, column clogging did not occur because of the large interspace. This can be seen from FIG. 26. In contrast, the passivation film severely accumulates on the surface of ZVI in the sand filter so that the ZVI reactivity was significantly hampered, as reflected by the increased DO concentration in FIG. 29B. The compact packing in the sand filter inhibits the corrosion products to flow away through the narrow gaps among ZVI and sand particles. Therefore, the flow rate of the sand filter decreases dramatically from 15.0 to 2.0 mL/min during the first 48 h because of column clogging, which is demonstrated in FIG. 29C.

Despite the high removal efficiency of As, the operation of the sand filter is unavoidable terminated after 60 hours due to the low water flow rate as a result of fast column clogging. Despite good hydraulic conductivity, the concentration of As_{aq} in the effluent of the MCCR 201 without PUD exceeded 10,μg/L after 1834 EBV and further increased to 50.84 μg/L until 6420 EBV (FIG. 28B, FIG. 30). Conversely, there was a steady decline in Asₛₒₗ concentration from 63.4 to 6.0 pug/L because of the decreased concentration of effluent solids (FIG. 29A). This result suggests gradual passivation of ZVI that suppresses the formation of corrosion products, as supported by increased DO concentration in the effluent (FIG. 29B). In addition, the passivation film that became gradually thickened with the increasing operation time is also noted. The strong magnetic field fails to address the issue of ZVI passivation, and the passivation needs to be solved to achieve more effective and sustainable As removal.

This issue can be well addressed by in-situ PUD with the ultrasonic generator 220 for polishing the ZVI surface to sustain the reactivity. With reference to FIG. 28C, the concentration of As_{aq} in the effluent can be maintained below 10 μg/L until 7338 EBV (173 L water), at least 4.0-folds that of the water treatment capacity of the other two systems. When the treated water volume further increased to 11006 EBV, the concentration of As_{aq} in the effluent gradually increased to 14.8 μg/L due to significant consumption of ZVI. Based on the CT images in FIG. 26, the PUD effectively peeled off the filled corrosion products precipitated on the surface of the plurality of ZVI wires 215 in the MCCR 201, indicated by the recovered interspace and thinner ZVI wires. The loss of corrosion products caused by PUD can also be observed from the enlarged interspace (3D view).

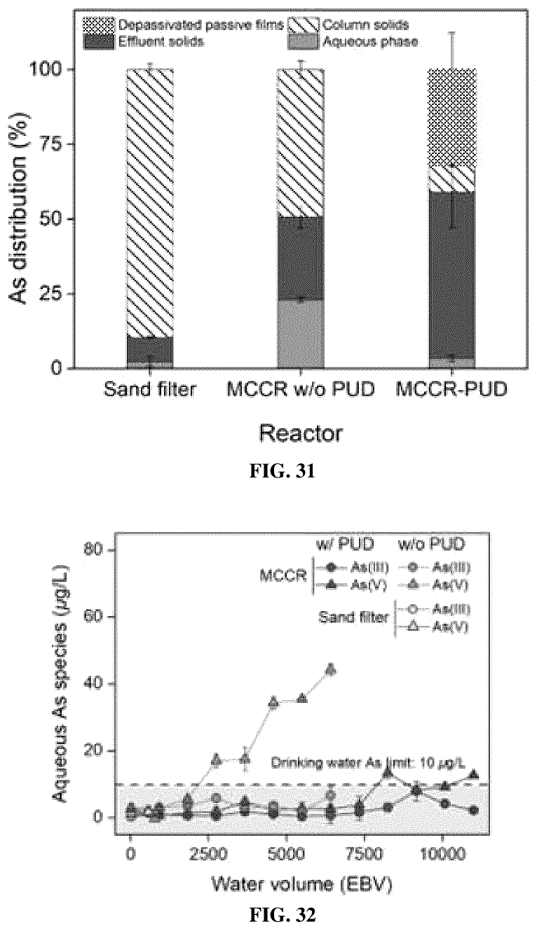

With reference to FIG. 31, a significantly higher fraction of As (56%) is sequestrated in the solids in the effluent 270 from the MCCR 201 with PUD, and 32% of As is sequestrated in the displaced passivation film, which would have been retained in the column solids if no PUD was implemented.

Referring to FIG. 32, the As speciation analysis reveals that As(V) is the dominant specie in the effluent of the MCCR 201, as the result of significant As(III) oxidation. This is independent of the use of PUD. The enhanced As(III) oxidation can be attributed to the depassivation effect by the magnetic field and the high concentration of DO available to the surface of the ZVI microparticles throughout the one or more column filters 210, which generates more oxidative species by reacting with reducing iron species.

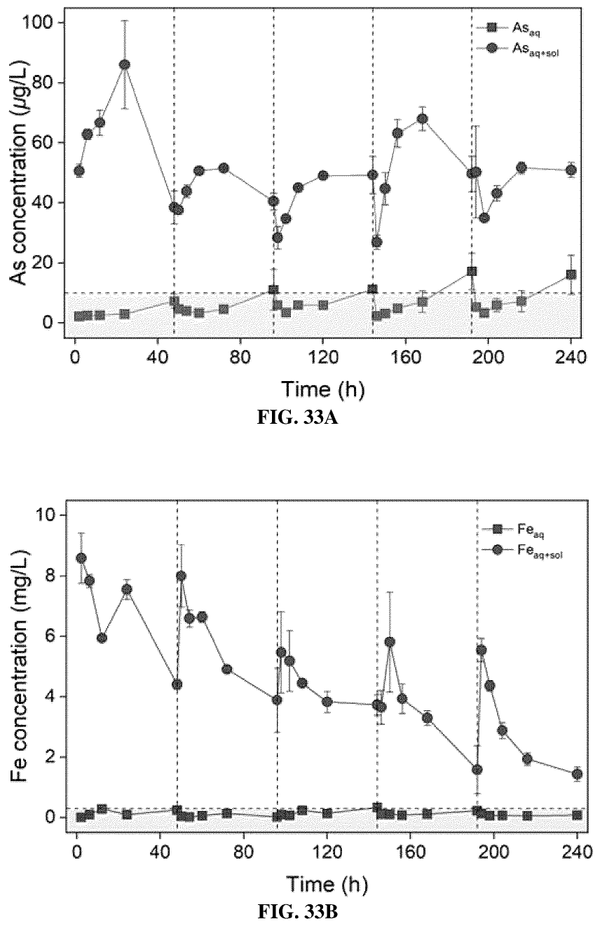

To investigate the effect of PUD on As removal, the ultrasonic generator 210 is activated for 1 minute every 48 hours. The feed solution 10 contains 100 pug/L As(III) and the flow rate is 15 mL/min. The total and aqueous As concentrations are measured at regular time intervals and shown in FIG. 33A. The total and aqueous Fe concentrations are also measured at regular time intervals and shown in FIG. 33B. It is noted that the concentration of As_{aq} drops immediately after PUD. However, the As_{aq} concentrations sampled at the same time point after PUD overall increases with the number of applied PUD due to the loss of corrosion products. Therefore, while PUD improves As removal, it also sacrifices long-term performance. Despite this, it can be solved by regularly supplementing ZVI to the one or more column filters 210. In conclusion, the MCCR 201 with PUD shows the ability to sustain the ZVI reactivity by removing the passivation layer and avoided the filter clogging, which facilitates the superior As removal performance even within a short total HRT of 95 seconds and a low dosage of ZVI of approximately 9 g.

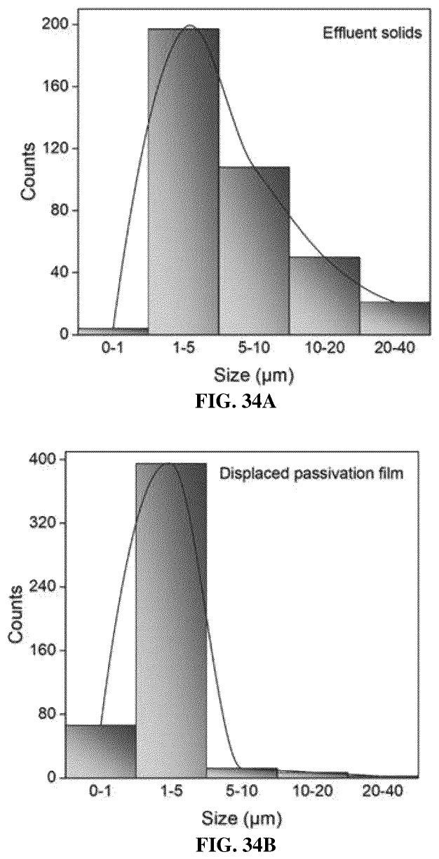

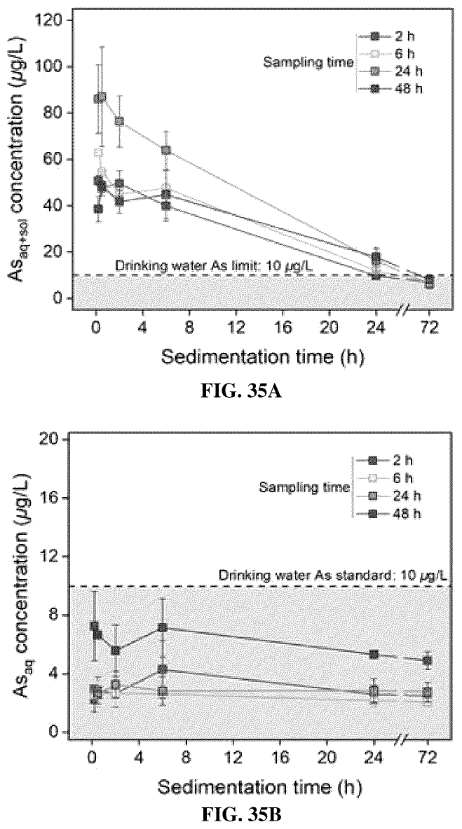

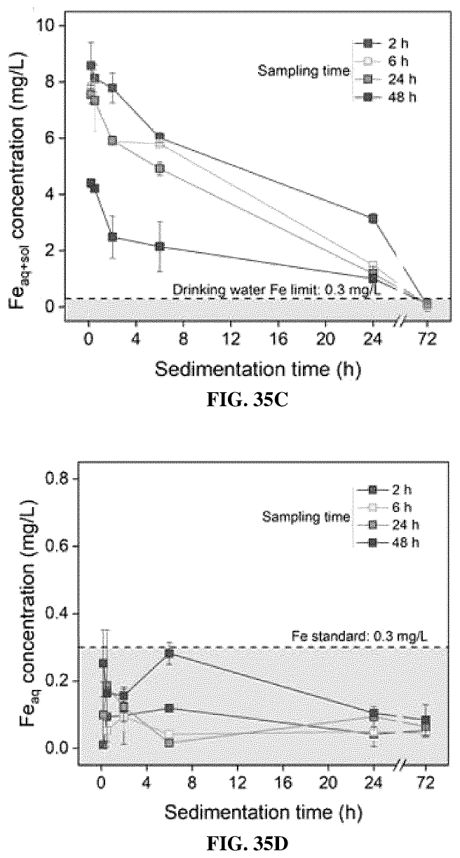

Considering the risk of the high concentration of As in the effluent solids, sedimentation of these solids is monitored and shown in FIGS. 34A and 34B. The particle sizes of both effluent solids and displaced passivation film are around 1-5 μm. However, there are much fewer particles larger than 5 μm from the displaced passivation film, which may be due to the breakup by ultrasonication. With the reactor running, the effluent became colourless because of less generated iron corrosion products, and the effluent solids settled to the bottom of the centrifuge tubes after 24 h. After 72 h, the concentrations of As_{aq+sol} and Fe_{aq+sol} decreased to below the limit of the drinking water criteria (FIG. 35A and FIG. 35C). In addition, no significant further removal of As_{aq} was observed during sedimentation (FIG. 35B), suggesting that the removal of As is already completed in the one or more column filters 210. The aqueous Fe concentration is also within the standard (FIG. 35D).

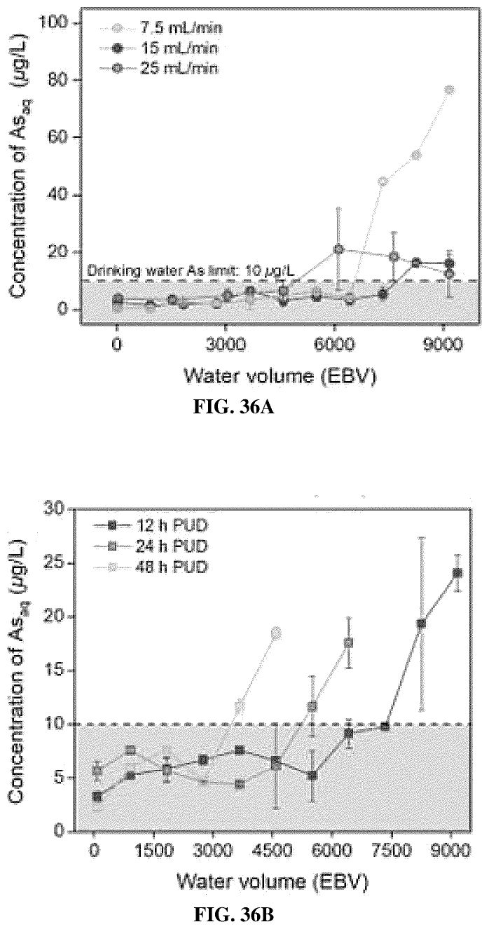

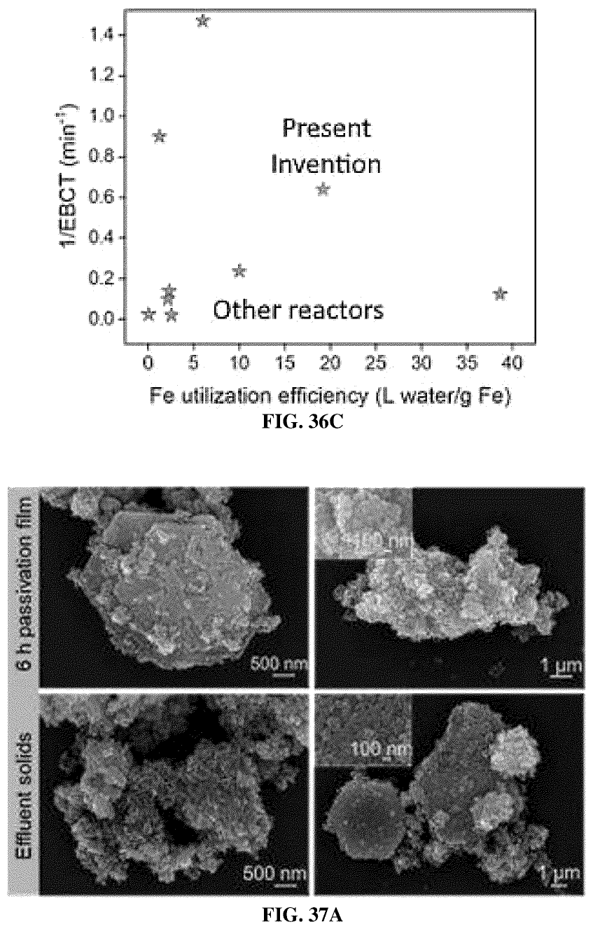

As shown in FIG. 36A, the MCCR 201 achieves the highest water treatment volume (7338 EBV) before breakthrough at a flow rate of 15 mL/min, compared to flow rates of 7.5 mL/min (6420 EBV) and 25 mL/min (4586 EBV). With a constant PUD frequency of 6 hours during daytime and 12 hours during nighttime, the lowest flow rate (7.5 mL/min) resulted in more PUD events for treating the same volume of water, causing greater ZVI loss in the plurality of ZVI wires 215. Moreover, the small amount of remaining ZVI cannot form an array structure, but instead is attracted to the column walls. This significantly reduces the effective contact between As and ZVI, leading to a sharp rise in the concentration of As in the aqueous phase. The fastest breakthrough at a flow rate of 25 mL/min can be explained by the shortest hydraulic retention time (HRT).

FIG. 36B demonstrates that the frequency of 12 h achieves the largest water treatment capacity before breakthrough (7338 EBV) due to the shortest passivation time, offers one of the highest ZVI utilization efficiencies and lowest EBCT compared with the reactors studied earlier, as provided in FIG. 36C.

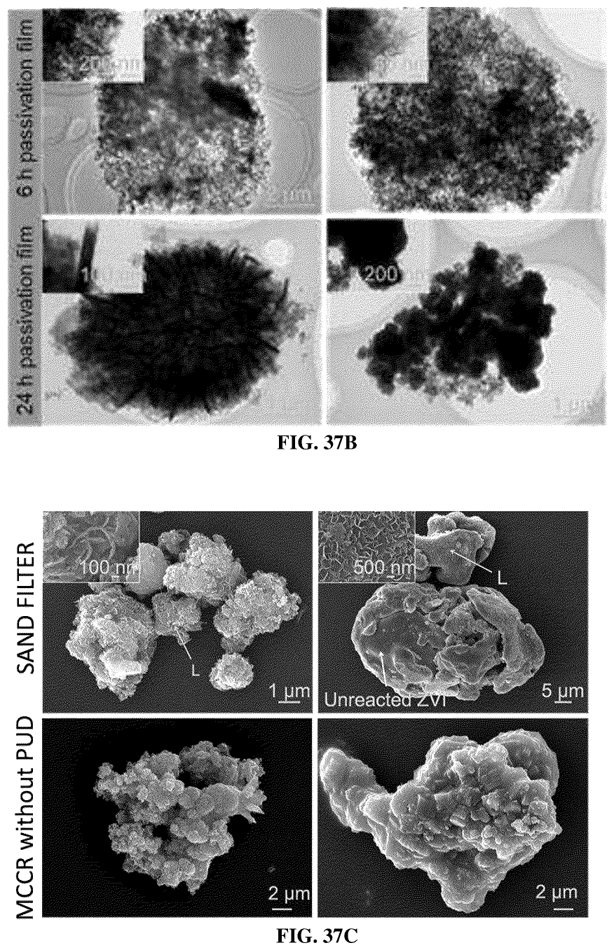

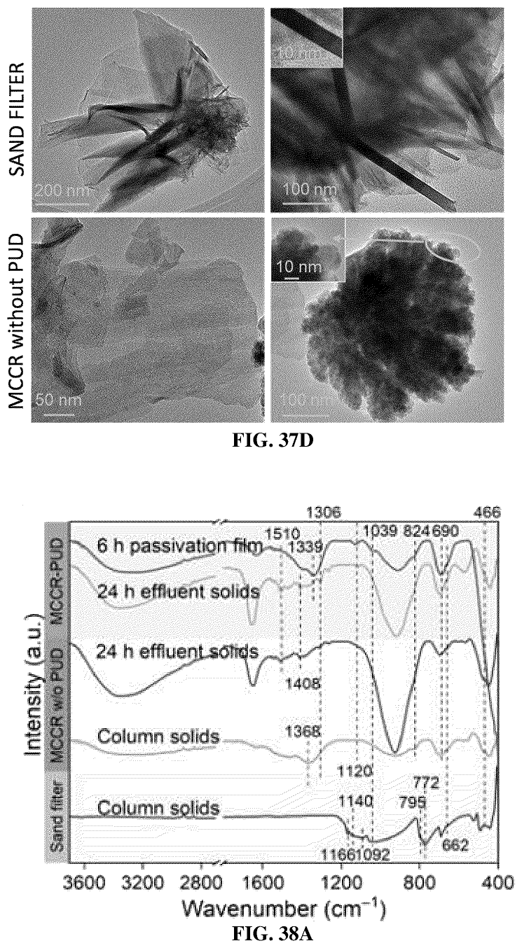

In FIG. 37A, the morphologies of iron-based corrosion products are observed using scanning electron microscopy (SEM). The surface of the effluent solids and displaced passivation film from the MCCR 201 with PUD is rough due to the severe corrosion of the ZVI. The rough surface of corrosion products in the MCCR 201 with PUD provides a higher surface area available for As sequestration. Notably, amorphous or poor crystalline iron (oxyhydr)oxide is identified as the main product, along with a small amount of lepidocrocite, in displaced passivation film from the MCCR 201 with PUD, as observed by transmission electron microscopy (TEM) (FIG. 37B). In contrast, as shown in FIG. 37C, the ZVI in both the conventional sand filter and the MCCR 201 without PUD are coated almost entirely with a dense passivation layer. Lepidocrocite, a relatively more crystalline mineral, was the predominant mineral in the corrosion products from the sand filter (FIG. 37D).

The crystalline minerals in the MCCR 201 may be generated during the ageing process of corrosion products, in which poor crystalline minerals are initially formed and subsequently transformed into more thermodynamically stable crystalline minerals. This transformation usually results in a reduced surface area and therefore, fewer adsorption sites. However, the process of lepidocrocite formation in the sand filter is distinct from that in the MCCR 201 with PUD, as no transformation of solids was found in the sand filter. Consequently, lepidocrocite was primarily formed by relatively slow ZVI oxidation and crystallization.

Additionally, the molar ratio of Fe to O in the corrosion products was found to increase with passivation time from 0.32 (6 hours) to 0.51 (24 hours), and further to 0.84 in the MCCR 201 without PUD (168 hours). The result is summarized in Table I below. This can be explained by the incomplete oxidation of corrosion products after long-term passivation. In conclusion, the morphological characterization indicated that the magnetic field accelerated ZVI corrosion but did not prevent the formation of passivation film after an extended period of reaction. This was evidenced by the transformation of minerals and decreased ZVI oxidation over time, which is consistent with the declined As removal performance shown in FIG. 30. These results emphasize the necessity of PUD for rejuvenating ZVI reactivity.

TABLE I
Atomic ratio of Fe to O in selected solid samples (Measured
by energy dispersive spectroscopy (EDS) in the TEM)

| Sample | Fe/O atomic ratio |
|---|---|
| 6-hour displaced passivation film | 0.32 |
| 24-hour displaced passivation film | 0.51 |
| 168-hour passivation film | 0.84 |

*Collected from the column solids in MCCR without PUD by ultrasonication and magnetic separation after 168 h-passivation

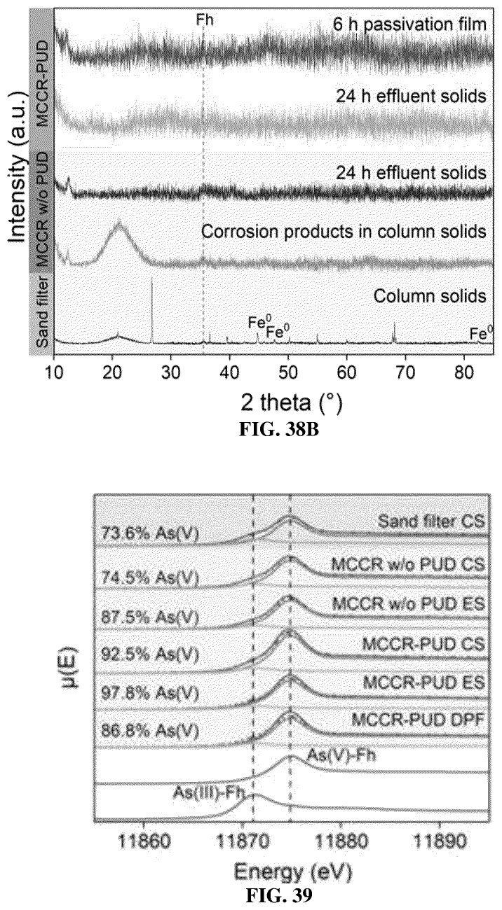

Fourier-transform infrared spectroscopy (FTIR) and X-ray diffraction (XRD) are also employed to analyze the chemical composition and crystal structure of the corrosion products. From the FTIR spectra (FIG. 38A), the MCCR promoted the production of iron (oxyhydr)oxides, particularly amorphous ferrihydrite (466 and 662 cm⁻¹), hydroxycarbonate green rusts (GRs) (690 cm⁻¹), and a small amount of lepidocrocite (1039 and 1120 cm⁻¹). The composition differs from that in the sand filter, which mainly consists of lepidocrocite (1039-1160 cm⁻¹) and goethite (795 cm⁻¹). Moreover, the peak at 772 cm⁻¹ likely indicates the presence of adsorbed As(III) species. The XRD pattern revealed that the strong magnetic field significantly accelerated ZVI corrosion, resulting in faster nucleation that favored the formation of amorphous (loose-structured) iron (oxyhydr)oxides (FIG. 38B Only Fe⁰ and a weak signal standing for ferrihydrite were detected in the column solids from the sand filter. This is due to the slow oxidation and severe passivation of column solids in the sand filter, leading to fewer corrosion products. The difference in mineral composition between the corrosion products from MCCR 201 with PUD, MCCR 201 without PUD, and the sand filter is consistent with the SEM and TEM results.

To explore the As removal mechanisms, As K-edge XANES spectra were analyzed to determine the oxidation state of As in the solid phase and As adsorption geometries. The valences of As in the solid samples from the three reactors were analyzed by linear combination fitting based on XANES spectra (FIG. 39). As(V) was identified as the dominant species in all samples. However, As(III) in the sand filter (73.6% of As(V)) was less oxidized than in the MCCR 201 with PUD (92.5% of As(V)) due to loss of ZVI reactivity from ZVI passivation and lack of oxygen supply. Passivation can also explain insufficient As oxidation in MCCR 201 without PUD (74.5%). As in effluent solids from the MCCR 201 without PUD (87.5% of As(V)) was more oxidized than in column solids. During ZVI oxidation, some effluent solids were homogeneously formed and flowed out, while others heterogeneously formed in situ on the ZVI surface and were carried away by water flow impact and shear. On the spatiotemporal scale, effluent solids attached to the ZVI surface were distributed in the outermost layer, forming under higher ZVI reactivity and relatively oxic conditions, causing more As(III) oxidation. After introducing PUD, 86.8%-97.8% of As(III) oxidized due to sustained ZVI reactivity. Thus, the MCCR 201 with PUD enhanced oxidation of As(III) to less toxic As(V) in the solid phase.

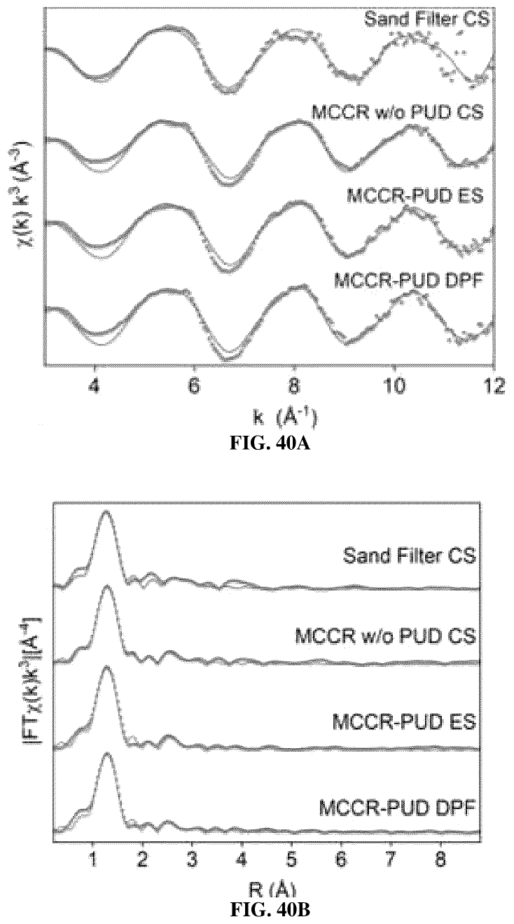

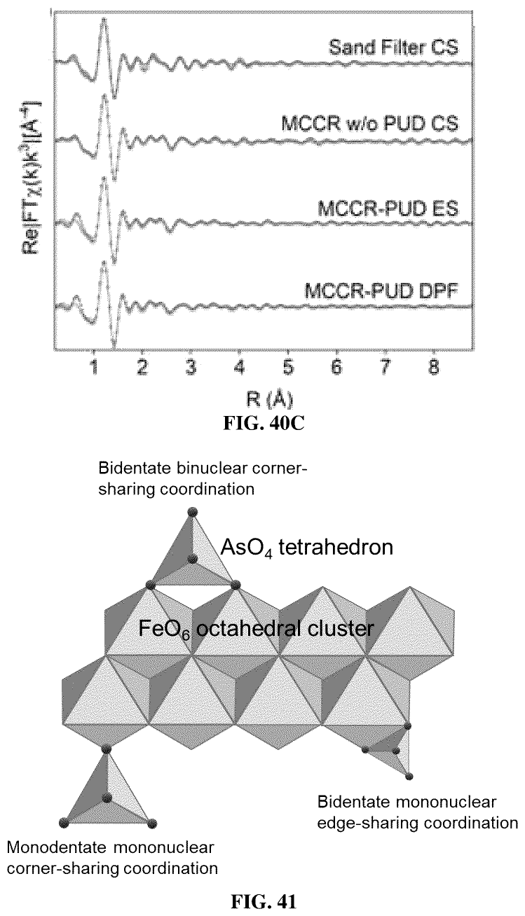

The coordination geometry of As in the solid samples was determined with EXAFS, as shown in FIGS. 40A-C. The first-shell fitting corresponds to As(V)-O coordination. The coordination number (CN) of As(V)-O (CN_{As-O}) in all samples was around 3.6-4.3, and RAs-O was 1.69-1.70 Å, close to the coordination geometry of tetrahedral AsO₄³⁻.

Refer to FIG. 41, As(V) can bind with iron oxide via inner-sphere surface complexes distinguished by three geometries: monodentate mononuclear corner-sharing (²C) coordination (R_{As-Fe} of 3.5-3.6 Å), bidentate mononuclear edge-sharing (²E) coordination (R_{As-Fe} of 2.8-2.9 Å), and bidentate binuclear corner-sharing (²C) coordination (R_{As-Fe} of 3.2-3.4 Å). The R_{As-Fe} values of the solid samples from the three systems were in the range of 3.24-3.32 Å, consistent with ²C coordination. However, the coordination number of As-Fe (CN_{As-Fe}) of residues in the sand filter and MCCR 201 without PUD was lower than the theoretical value. Previous studies have suggested that the low coordination numbers are attributed to relatively higher surface coverages. The other possible reason is the difference in the As removal mechanisms of the sand filter, MCCR 201 without PUD, and the MCCR 201 with PUD. Although adsorption and coprecipitation were possible in the treatment process, their contribution to As removal could differ. A previous study found that the coordination number of antimony-iron by coprecipitation was larger than that by adsorption because of structural incorporation. Therefore, a higher contribution of coprecipitation may explain the larger CN_{As-Fe} of solids from the MCCR 201 with PUD, inspiring further exploration of the respective contribution of adsorption and coprecipitation for As removal.

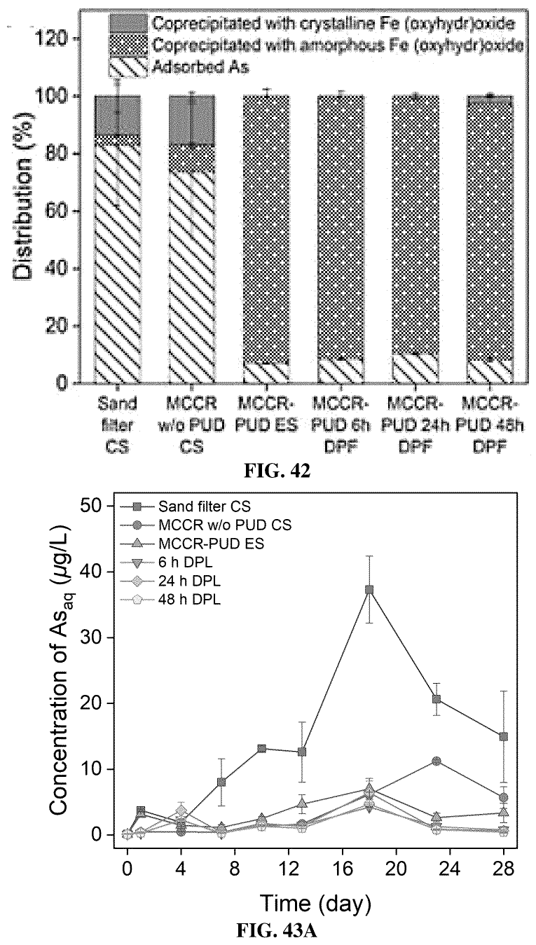

To quantify the varied fractions of As removed via adsorption and coprecipitation, a sequential extraction experiment was conducted. The As removal mechanisms of MCCR-PUD were distinct from that of the sand filter and MCCR 201 without PUD. According to FIG. 42, 90-92% of As coprecipitated with amorphous iron (oxyhydr)oxide in the solids from MCCR-PUD. Conversely, surface adsorption was dominant in the residues from the sand filter (83.02%) and MCCR 201 without PUD (73.68%). As the main corrosion product in the MCCR 201 with PUD, amorphous iron (oxyhydr)oxide forms by oxidation of Fe(II) and polymerization of Fe(III). A previous study reported that As sequestration during coprecipitation was faster than Fe(III) polymerization, and high Fe(III) concentration in the MCCR 201 with PUD favored a coprecipitation-dominated mechanism. Notably, 2.57% of As was extracted from crystalline iron oxides in the passivation film displaced after 48 h of reaction. While for the other solid samples from MCCR 201 with PUD, no As was extracted at this step. This indicates the transformation of amorphous iron (oxyhydr)oxide into more crystalline minerals over a relatively longer passivation time, further confirmed by the higher proportion of extracted As from residues of MCCR without PUD (17.11%, after 168 h operation). In addition, for the MCCR 201, as ZVI reactivity decreased over time and insufficient Fe(III) produced to complete coprecipitation due to passivation, adsorption would be the main removal process (18.47%-20.56% for the MCCR 201 with PUD, 73.68% for the MCCR 201 without PUD).

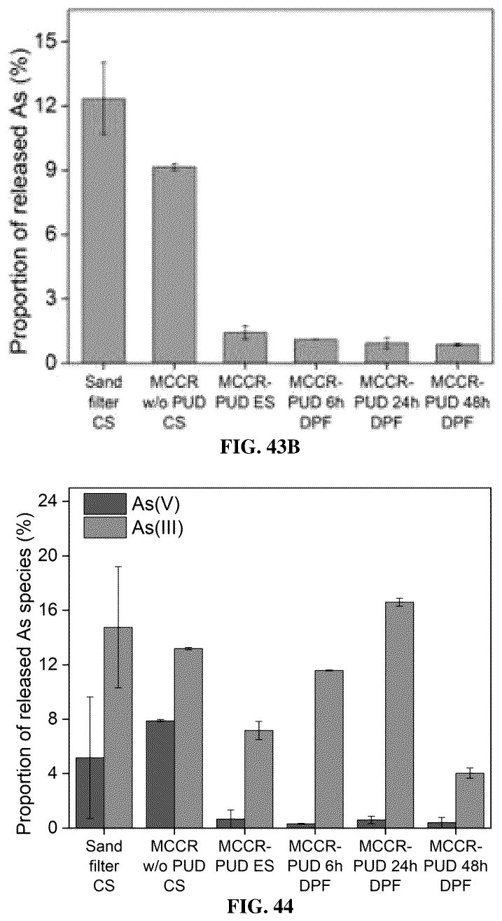

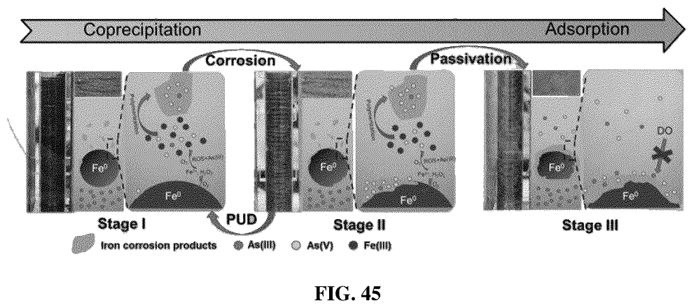

Next, the remobilization of As during solid ageing was analyzed. For the sand filter, As in the corrosion products started to release into the water on the 7^{th} day, and the released As from the solids in the sand filter was the highest among all the solid samples until the 28^{th} day (FIG. 43A). The maximum concentrations of released As were then used to calculate the proportion of As released. The proportion of released As in the residues from the sand filter was over 12%, followed by the residues from MCCR 201 without PUD (9%) (FIG. 43B). However, all the solids from the MCCR 201 with PUD showed stable As immobilization (˜1%), which suggested a low risk of subsequent solid disposal. During the ageing process, the transformation of minerals is always accompanied by a reduction in surface area, which results in the desorption and release of As from the solid surface. It explained the high release of As in the solids from the sand filter and the MCCR 201 without PUD. On the contrary, the less release of As in the solids from the MCCR 201 with PUD suggests that coprecipitation (structural incorporation) is the dominant As removal mechanism. The structural incorporation of As into the iron(III) oxide has been found to better immobilize As compared with surface adsorption. In addition, despite the diffusion of As in the solids, the low ratio of As to Fe (<0.01) in our samples may cause re-adsorption of As on the active sites. As(III) was found to have higher mobility compared with As(V) (FIG. 44), which further showed the advantage of oxidation in the MCCR 201 with PUD. In addition, the low disposal risk was further proved by the results of TCLP, as shown below in Table II.

TABLE II
Leaching concentration of As in
the solids from MCCR-PUD in TCLP

| | As concentration | TCLP Limit |
|---|---|---|
| Sample | (μg/L) | (μg/L) |
| Column residues | 31.91 ± 8.82 | 5000 |
| Effluent solids | 28.82 ± 2.33 | |
| Displaced passivation film | 37.78 ± 2.70 | |

Therefore, as shown in FIG. 45, the dominant mechanism shifted from coprecipitation to adsorption with the passivation process, during which the ZVI surface was gradually covered by the passivation film. However, the short HRT does not allow the adsorption process to effectively remove As. Thus, after introducing PUD, the process can be regulated by inhibiting the transformation from coprecipitation to adsorption, which results in a faster and more sustainable As oxidation and removal. Furthermore, the remobilization risk was reduced because of the structural incorporation of As.

The present disclosure demonstrates that the MCCR 201 with PUD exhibits excellent ZVI hydrodynamic stability, high surface area, and avoids the issue of clogging associated with the conventional sand filters. This novel system and the respective method facilitate the introduction of PUD and aeration, enabling sustainable oxidation and sequestration of As within a short HRT. The high reactivity of ZVI, sustained cooperatively by the magnetic field and PUD, allows for considerable production of localized Fe(II) and Fe(III) and subsequent rapid nucleation. During this process, As (mainly as As(V)) is structurally incorporated into the iron oxide (appearing as a passivation film and effluent solids) formed by fast polymerization.

The current water production of the MCCR 201 with PUD (21-22 L/day) is easily elevated to meet the clean drinking water needs of a family household of three people (i.e., 8 L/day per person by WHO recommendation). Additionally, compared with the conventional sand filters, As-bearing iron sludge from the MCCR 201 with PUD exhibits lower As remobilization due to the structural incorporation of As, thereby reducing the risk of secondary pollution and treatment costs for subsequent waste disposal.

In conclusion, the water treatment system 200 having the MCCR 201 shows the potential to surpass the performance of sand filters and become the next generation of decentralized water treatment reactors for As removal in groundwater.

This illustrates the HF-MCR 101 and the MCCR 201 in accordance with the present disclosure. It will be apparent that variants of the above-disclosed and other features and functions, or alternatives thereof, may be integrated into various water treatment systems. The present embodiment is, therefore, to be considered in all respects as illustrative and not restrictive. The scope of the disclosure is indicated by the appended claims rather than by the preceding description, and all changes that come within the meaning and range of equivalency of the claims are therefore intended to be embraced therein.

What is claimed is:

1. A system for removing contaminant from a feed solution using a sequential combination of filtration and catalysis, the system comprising:
a hollow fiber membrane chemical reactor (HF-MCR) comprising:
a filtration zone at a frontend of the HF-MCR, comprising a filtration chamber and an inlet;
a catalysis zone at a backend of the HF-MCR being a magnetically confined zone; and
one or more hollow fiber membranes (HFMs) disposed across the filtration zone and the catalysis zone, wherein the one or more HFMs disposed across the catalysis zone comprise zerovalent iron (ZVI) nanoparticles; and
a magnetic field generator arranged to produce a magnetic field around the one or more HFMs at the catalysis zone for realizing the magnetically confined zone that results in a formation of a plurality of microwires comprising the ZVI nanoparticles in a lumen of each of the one or more HFMs as a magnetic catalyst to enable catalytic degradation and chemical immobilization of the contaminant,
wherein:
the filtration chamber is filled with the feed solution from the inlet, and the HFM establishes a fluid communication between the filtration chamber and the one or more HFMs as means for communicating the feed solution into the one or more HFMs under an outside-in mode at the filtration zone.

2. The system of claim 1 further comprising a first pump for loading and reloading the catalysis zone with a ZVI suspension comprising the ZVI nanoparticles, wherein the ZVI suspension forms the plurality of microwires in a presence of the magnetic field.

3. The system of claim 2, wherein the ZVI suspension is injected into the one or more HFMs with a water flow rate ranging from 2 cm/s to 15 cm/s such that the ZVI nanoparticles are localized in the magnetically confined zone for forming the plurality of microwires having interspaces between the plurality of microwires.

4. The system of claim 1 further comprising a second pump and a third pump, wherein the second pump injects an oxidant solution into the one or more HFMs, and the third pump injects the feed solution to the filtration chamber via the inlet in a dead-end filtration mode.

5. The system of claim 4, wherein the oxidant solution comprises peroxymonosulfate (PMS), peroxydisulfate, hydrogen peroxide, or dissolved O₂ or O₃.

6. The system of claim 4, wherein the feed solution, upon filtering nanoplastics (NPs) by the HFM, is mixed with the oxidant solution in the one or more HFMs with a water flux ratio ranging from 10:1 to 100:1.

7. The system of claim 1, wherein the filtration zone further comprises an outlet for discharging the feed solution in a backwashing mode for membrane washing.

8. The system of claim 1, wherein the magnetic field generator comprises a plurality of magnets sandwiching the HF-MCR at the catalysis zone, and wherein the plurality of magnets comprises a neodymium (NdFeB) magnet, a samarium-cobalt magnet, an Alnico magnet, a ferrite magnet, or an electromagnet.

9. The system of claim 8, wherein the plurality of magnets forms a diametrically magnetized ring magnet arranged to surround the one or more HFMs.

10. The system of claim 8, wherein the plurality of magnets comprises a stack of eight cylindrical NdFeB magnets arranged to sandwich the HF-MCR with a gap of a predetermined thickness; and wherein the magnetic field is oriented perpendicular to a water flow direction of the feed solution and the oxidant solution in the one or more HFMs, thereby the plurality of microwires are aligned vertically to improve hydrodynamic stability.

11. The system of claim 1, wherein the HFM is a polytetrafluoroethylene (PTFE) membrane, a polyethersulfone (PES) membrane, a polyvinylidene fluoride (PVDF) membrane, or a ceramic membrane, with a membrane pore size of 10-100 nm.

12. The system of claim 1, wherein the contaminant comprises one or more contaminants comprising colloids, bisphenol A (BPA), bisphenol F (BPF), bisphenol S (BPS), sulfamethoxazole (SMX), dichlorophenol (DCP), nitrophenol (NP), acetaminophen (APAP), trichloroacetic acid (TCAA), phosphorus (P) containing pollutants, arsenic (As) containing pollutants, and antimony (Sb) containing pollutants.

13. A method for removing contaminant from a feed solution using a hollow fiber membrane chemical reactor (HF-MCR), the HF-MCR comprising a filtration zone, a catalysis zone, and a hollow fiber membrane (HFM) disposed across the filtration zone and the catalysis zone, the method comprising:
injecting, by a first pump, a ZVI suspension comprising zerovalent iron (ZVI) to the HFM for forming a plurality of microwires comprising ZVI nanoparticles by a magnetic field in a lumen of the catalysis zone as a magnetic catalyst;
injecting, by a second pump, an oxidant solution to the HFM;
injecting, by a third pump, the feed solution to a filtration chamber of the filtration zone;
establishing a fluid communication of the feed solution from the filtration chamber to the HFM under an outside-in mode to mix with the oxidant solution; and
activating the oxidant solution in the catalysis zone by the plurality of microwires to enable catalytic degradation and chemical immobilization of the contaminant from the feed solution.

14. The method of claim 13, wherein the catalysis zone is sandwiched between two sets of magnets for realizing a magnetically confined zone, and wherein the magnetic field is oriented perpendicular to a flow direction of the feed solution and the oxidant solution in the HFM.

15. The method of claim 13 further comprising the step of injecting, from time-to-time, by the first pump, the ZVI suspension comprising the ZVI nanoparticles into the HFM for reloading the ZVI nanoparticles in the catalysis zone.

16. The method of claim 13 further comprising the step of discharging, from time-to-time, the feed solution from the filtration chamber in a backwashing mode for membrane washing.

17. The system of claim 13, wherein the oxidant solution comprises peroxymonosulfate (PMS), peroxydisulfate, hydrogen peroxide, or dissolved O₂ or O₃.

18. The system of claim 13, wherein the feed solution and the oxidant solution are injected into the HFM with a water flux ratio ranging from 10:1 to 100:1.

19. The method of claim 13, the HFM is a polytetrafluoroethylene (PTFE) membrane, a polyethersulfone (PES) membrane, a polyvinylidene fluoride (PVDF) membrane, or a ceramic membrane, with a membrane pore size of 10-100 nm.

20. The method of claim 13, wherein the contaminant comprises one or more contaminants comprising colloids, bisphenol A (BPA), bisphenol F (BPF), bisphenol S (BPS), sulfamethoxazole (SMX), dichlorophenol (DCP), nitrophenol (NP), acetaminophen (APAP), trichloroacetic acid (TCAA), phosphorus (P) containing pollutants, arsenic (As) containing pollutants, and antimony (Sb) containing pollutants.

21. A system for removing arsenic (As) from a feed solution, the system comprising:
a magnetic confinement-enabled column reactor (MCCR) being a flow-through reactor, comprising:
one or more column filters oriented along a vertical direction, wherein each of the one or more column filters is filled with microscale zerovalent iron (ZVI); and
a magnetic field generator arranged to produce a magnetic field around the one or more column filters for realizing a magnetically confined zone that results in a formation of a plurality of ZVI wires comprising ZVI microparticles within the one or more column filters for reducing aqueous As (As_{aq}) concentration in the feed solution after the feed solution is pumped through the one or more column filters; and
an ultrasonic generator coupled to the one or more column filters and capable of periodically applying ultrasonic energy to the plurality of ZVI wires to sustain reactivity.

22. The system of claim 21, wherein the one or more column filters are arranged in parallel; and wherein each of the one or more column filters comprises an upper outlet and a lower inlet for allowing the feed solution to flow in a bottom-up flow direction.

23. The system of claim 22, wherein the one or more column filters comprises three column filters connected in tandem by a plurality of pipelines; and wherein the feed solution is pumped into the MCCR from the lower inlet.

24. The system of claim 23 further comprising a peristaltic pump configured to pump the feed solution into the lower inlet of the first column filters.

25. The system of claim 23, wherein the three column filters comprise a first column filter, a second column filter, and a third column filter, wherein the feed solution is pumped into the lower inlet of the first column filter; and wherein the first column filter is in fluid communication with the second column filter by connecting a first pipeline from the upper outlet of the first column filter to the lower inlet of the second column filter; and wherein the second column filter is in fluid communication with the third column filter by connecting a second pipeline from the upper outlet of the second column filter to the lower inlet of the third column filter.

26. The system of claim 21, wherein the ultrasonic generator is configured to be activated, from time to time, to apply the ultrasonic energy to the one or more column filters to eliminate surface passivation of the ZVI microparticles in the plurality of ZVI wires.

27. The system of claim 26, wherein the ultrasonic generator has an ultrasonic frequency ranging from 40 kHz to 100 kHz.

28. The system of claim 21 further comprising an air pump and a hydrophobic filter, wherein the air pump is configured to inject air into the feed solution for improving dissolved oxygen (DO) concentration.

29. The system of claim 21, wherein the magnetic field generator comprises a plurality of magnets sandwiching the MCCR, and wherein the plurality of magnets comprises a neodymium (NdFeB) magnet, a samarium-cobalt magnet, an Alnico magnet, a ferrite magnet, or an electromagnet.

30. The system of claim 29, wherein the plurality of magnets and the one or more column filters are arranged in an interleaving manner, and each of the one or more column filters is sandwiched by two of the plurality of magnets.

31. The system of claim 29, wherein the magnetic field has a magnetic flux density of 0.3 T to 0.6 T.

32. A method for removing arsenic (As) from a feed solution using a magnetic confinement-enabled column reactor (MCCR), the MCCR comprising one or more column filters vertically arranged and a magnetic field generator, the method comprising:
loading zerovalent iron (ZVI) microparticles to the MCCR by filling the one or more column filters with microscale ZVI, wherein the magnetic field generator induces a magnetic field around the one or more column filters for realizing a magnetically confined zone that results in a formation of a plurality of ZVI wires comprising the ZVI microparticles within the one or more column filters;
injecting, by a peristaltic pump, the feed solution into the one or more column filters in a bottom-up flow direction; and
activating, from time to time, an ultrasonic generator to apply ultrasonic energy to the plurality of ZVI wires to sustain reactivity.

33. The method of claim 32 further comprising the step of injecting, by an air pump and a hydrophobic filter, air into the feed solution for improving dissolved oxygen (DO) concentration.

34. The method of claim 32, wherein the one or more column filters comprises three column filters connected in tandem by a plurality of pipelines; and wherein the three column filters are arranged in parallel.

35. The method of claim 32, wherein the magnetic field generator comprises a plurality of magnets sandwiching the MCCR.

36. The method of claim 35, wherein the plurality of magnets and the one or more column filters are arranged in an interleaving manner, and each of the one or more column filters is sandwiched by two of the plurality of magnets.

37. The method of claim 35, wherein the magnetic field has a magnetic flux density of 0.3 T to 0.6 T.

38. The method of claim 32, wherein the ultrasonic generator is activated regularly for approximately 1 minute based on a periodic ultrasonic depassivation (PUD) frequency that is determined based on a flow rate of the feed solution, thereby surface passivation of the ZVI microparticles in the plurality of ZVI wires is eliminated.

39. The method of claim 38, wherein the PUD frequency ranges from 2 hours to 24 hours.

40. The method of claim 38, wherein the ultrasonic generator has an ultrasonic frequency ranging from 40 kHz to 100 kHz.
